(19) United States
(12) Patent Application Publication
(10) Pub. No.: US 2025/0059070 A1
(43) Pub. Date: Feb. 20, 2025

(54) AMMONIA AND NUTRIENT ION RECOVERY FROM MANURE WASTEWATER AND ELECTROSYNTHESIS OF VALUE-ADDED CHEMICALS USING ION SELECTIVE REDOX MATERIAL

(71) Applicant: Wisconsin Alumni Research Foundation, Madison, WI (US)

(72) Inventors: Song Jin, Madison, WI (US); Rui Wang, Madison, WI (US)

(21) Appl. No.: 18/451,643

(22) Filed: Aug. 17, 2023

(51) Int. Cl. C02F 1/461; C02F 1/467

(52) U.S. Cl. CPC C02F 1/46109; C02F 1/4672; C02F 2001/46133; C02F 2101/16; C02F 2103/20; C02F 2201/46115; C02F 2305/00

(57) ABSTRACT

A method for recovering NH₄⁺ or K⁺ ions from manure wastewater is disclosed. The method includes contacting manure wastewater having organic matter and salts with an ion-selective redox material with ionic channels. The manure wastewater reduces the ion-selective redox material which spontaneously takes up NH₄⁺ or K⁺ ions from the manure wastewater. NH₄⁺-or K⁺ may be released electrochemically and paired with the simultaneous electrosynthesis of value-added chemicals.

### STATEMENT REGARDING FEDERALLY SPONSORED RESEARCH

This invention was made with government support under 2219089 awarded by the National Science Foundation. The government has certain rights in the invention.

### FIELD OF THE INVENTION

The disclosed technology is generally directed to recovery of ammonium and other desirable nutrient ions. More particularly the technology is directed to an electrochemical process for the recovery of ammonium and potassium ions.

### BACKGROUND OF THE INVENTION

Livestock systems provide humans with protein-rich foods, but they are increasingly under pressure to become environmentally sustainable. Many environmental issues stem from managing livestock manure wastewater, a mixture of animal feces, urine, and other system by-products (e.g., waste feed, wash waters). Manure constituents, including nutrients, pathogens, and organic matter, can be lost to the environment during the current manure management process, which is simply storing and spreading the manure to nearby cropland as a fertilizer to reuse the nutrient. Such treatment of manure causes nuisance odors, degrades both surface and groundwater quality, contributes to climate change, thus creating many environmental and human health issues. To address these issues, manure processing systems capable of recovering embedded nutrients in a more manageable form with an increased nutrient density and value need to be developed. Although manure separation systems and microbiological processes are increasingly used for manure treatment, these systems are usually cost-and energy-intensive and have poor separation selectivity for the desired nutrients. In comparison, electrochemical processes driven by renewable electricity could be promising for distributed small-scale nutrient recovery and, especially, selective recovery of ammonia from manure wastewater.

Electrochemical ammonia recovery from wastewater has been focused on membrane-based processes using ion-exchange membranes, such as bioelectrochemical systems, electrochemical stripping, and electrodialysis. The separation of ammonia is usually achieved by the diffusion and migration of ammonium (NH₄⁺) ions across the cation-exchange membrane, and subsequently, the transported NH₄⁺ ions can be further concentrated and recovered as valuable products. All of these ammonia recovery processes must take place in complete electrochemical reaction cycles. However, the cathodic and anodic half-reactions in these electrochemical processes are not directly involved in the ammonia recovery processes. Instead, they are usually “sacrificial” reactions that decompose the electrolytes or oxidize the organic matter to provide the electric potential gradient to drive the migration of NH₄⁺ ions and maintain the charge and ion balance. Furthermore, the use of ion-exchange membranes increases the cost and complexity of the electrochemical devices. There remains a need for integrating the recovery of valuable ammonia and other nutrient ions from manure wastewater with an electrochemical system.

### SUMMARY

Disclosed herein is a method for recovering NH₄⁺ or K⁺ from manure wastewater. The method includes contacting a manure wastewater with organic matter and salts with an ion-selective redox material having ionic channels. Contacting the manure wastewater with the ion-selective redox material reduces the ion-selective redox material to form a reduced material, and the reduced material spontaneously takes up NH₄⁺ or K⁺ ions from the manure wastewater to form an ion-loaded material. In one embodiment, the reduced material takes up NH₄⁺ and K⁺ preferentially over Na⁺. In some embodiments, the ion-selective redox material is a Prussian Blue analog. In other embodiments, the ion-selective redox material is one of potassium nickel hexacyanoferrate or copper hexacyanoferrate. According to an aspect, the method further includes the steps of applying a current to the ion-loaded material, where applying the current to the ion-loaded material oxidizes the ion-loaded material to release the NH₄⁺ or K⁺ ions from the ion-loaded material.

Further disclosed herein is a method for utilizing NH₄⁺ or K⁺ ions, where the method includes applying a current to an ion-loaded material. Applying the current to the ion-loaded material oxidizes the ion-loaded material to release NH₄⁺ or K⁺ ions from the ion-loaded material. In one embodiment, the oxidation of the ion-loaded material is coupled to a cathodic reaction. In another embodiment the cathodic reaction is a hydrogen evolution reaction. In a further embodiment, the cathodic reaction is a two-electron oxygen reduction reaction producing H₂O₂, optionally where the cathodic reaction is separated from the anodic reaction by a separator.

A system for treatment of manure wastewater is disclosed herein, where the system includes a manure waste supply having manure wastewater therein, a cell having at least one inlet and at least one outlet, and a wastewater treatment chamber. The cell has an ion-selective redox material disposed therein. The inlet is fluidly coupled to the manure wastewater supply, where the outlet is fluidly coupled to the wastewater treatment chamber. The manure wastewater flows from the manure waste supply into the cell through the inlet, contacts the ion-selective redox material, and exits the cell through the outlet to the wastewater treatment chamber. The manure wastewater comprises organic material and salts.

In some embodiments, the organic material reduces the ion-selective redox material upon contact to form a reduced material, where the reduced material spontaneously takes up NH₄⁺ ions or K⁺ from the manure wastewater to form an ion-loaded material. In certain embodiments, the ion-selective redox material is a Prussian Blue analogue. In further embodiments, the ion-selective redox material is one of potassium nickel hexacyanoferrate or copper hexacyanoferrate.

According to an aspect, the ion-selective redox material is incorporated into an electrode having an electrical connection outside the cell. In some embodiments, a current applied to the electrode through the electrical connection oxidizes the ion-loaded material and releases the NH₄⁺ or K⁺ ions. In further embodiments, the oxidation of the ion-loaded material is coupled to a cathodic reaction. In still further embodiments, the cathodic reaction is a hydrogen evolution reaction. In particular embodiments, the cathodic reaction is a two-electron oxygen reduction reaction producing H₂O₂. In other embodiments, the cathodic reaction is separated from the anodic reaction by a separator. In certain embodiments, the H₂O₂ is directed to the wastewater treatment chamber.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. Panel (a) shows a schematic illustration of the simultaneous ammonia recovery and electrochemical synthesis system using ammonium ion-selective redox reservoir (RR). a, The system includes the NH₄⁺ uptake, fertilizer production, electrochemical synthesis, and wastewater treatment processes. The NH₄⁺ or K⁺ ion uptake process and the RR reduction occur spontaneously, driven by the oxidation of organic matter in manure wastewater (cell). Then, the RR electrodes are transferred into electrochemical cells to release recovered NH₄⁺ or K⁺ and produce NH₄⁺- and/or K⁺-rich fertilizer when the RR is oxidized (second cells). The oxidation of the RR electrode is paired with cathodic reactions, such as hydrogen evolution reaction (HER) and two-electron oxygen reduction reaction (2 e⁻ ORR), to produce H₂ or H₂O₂. The produced H₂O₂ solution that contains relatively concentrated K⁺ could be used for wastewater disinfection. After nutrient ion recovery and H₂O₂ disinfection, drying treated manure wastewater could recycle K⁺-rich salts as electrolytes or fertilizers. Cation (b) and anion (c) analyses of the manure wastewater are shown in b, chromatograms of cations in manure wastewater before (1) and after recovery processes (2) with a 1:400 dilution and the 5 ppm standard cation solution (3), and c, chromatograms of anions in manure wastewater with a 1:500 dilution (2) and the standard solutions of 7 common anions (1) and acetate (3).

FIG. 2. Structural characterizations of the KNiHCF material. a, Crystal structure of the KNiHCF, which has similar structure to CuHCF but different transition metal elements or intercalated cations. b, SEM image of the as-synthesized KNiHCF nanoparticle.

FIG. 3. Scanning electron microscope (SEM) images of the as-synthesized Prussian blue analog (PBA) samples. a, NaNiHCF. b, CuHCF. The particle size of the as-synthesized NaNiHCF was ˜2 μm, and the size of CuHCF was ˜20-50 nm.

FIG. 4. Powder X-ray diffraction (PXRD) patterns of the as-synthesized KNiHCF, CuHCF, and NaNiHCF materials. For the as-synthesized KNiHCF and CuHCF materials, the characteristic (200), (220), and (400) diffraction peaks match well with the standard pattern of the cubic phase of Prussian Blue (JCPDS No. 52-1907). The PXRD pattern collected on the NaNiHCF sample fits the rhombohedral structure of Prussian Blue with doublet diffraction peaks at (220), (420), (440), and (620).

FIG. 5. Thermogravimetric analysis (TGA) of various Prussian blue analog (PBA) samples. a, CuHCF. b, KNiHCF. c, NaNiHCF. The TGA tests were carried out at a ramp rate of 10° C. min⁻¹ under N₂ atmosphere. The water contents were calculated based on the weight loss as labeled in each panel.

FIG. 6. Electrochemical characterizations of the CuHCF electrode in manure wastewater. a, Cyclic voltammograms of the CuHCF electrode before and after 1-cycle galvanostatic charge-discharge (GCD) test in manure wastewater at 2 C rate. The scan rate was 10 mV s⁻¹. The 1 C rate is defined as 65 mA g⁻¹ based on the theoretical capacity (65 mAh g⁻¹) of these PBA electrodes, thus 2 C rate is 130 mA g⁻¹. b, Cycling stability of the CuHCF and KNiHCF electrodes in manure wastewater with a pH of ˜7 or ˜9 at 2 C rate. c, PXRD patterns collected on the CuHCF electrodes cycling in synthetic wastewater (sww), after 1-cycle CV in manure wastewater, and after GCD cycling tests in manure wastewater. d, Capacity retention and Coulombic efficiency (CE) of the CuHCF electrode in manure wastewater with a pH of ˜7.

FIG. 7. Cycling stability of the various PBA electrodes in weakly alkaline solutions. GCD tests at 2 C rate (130 mA g⁻¹) were conducted to evaluate the cycling stability of these PBA electrodes (CuHCF, NaNiHCF and KNiHCF) in various solutions (0.5 M KHCO₃ with a pH of ˜8.3, manure wastewater with a 1:4 dilution and a pH of ˜9, and manure wastewater with a pH of ˜7).

FIG. 8. Electrochemical characterizations of the KNiHCF material. a, Cycling stability of the KNiHCF electrode in various solutions at 2 C rate (130 mA g⁻¹): 1 M NaCl, 1 M KCI, 1 M NH₄Cl, synthetic manure wastewater (sww, 0.50 M NH₄Cl+0.183 M KHCO₃+0.146 M NaHCO₃), and manure wastewater with a pH of ˜7 or ˜9. b, Cyclic voltammograms of the KNiHCF electrode in 1 M NaCl, 1 M KCl, and 1 M NH₄Cl solutions at 1 mV s⁻¹. c, Calculated intercalation potential difference between NH₄⁺ and Na⁺(line 1) or K⁺(line 2) at different molar ratios of NH₄⁺/Na⁺ or K⁺. The red dots show the actual molar ratios of NH₄⁺ /Na⁺ or K⁺ in the manure wastewater studied herein. The red ellipse shows the representative molar ratios of NH₄⁺ /Na⁺ or K⁺ in common municipal wastewater (details in Table 4). d, Self-reduction behaviors of the KNiHCF electrode in synthetic and natural manure wastewater. The potential of the KNiHCF electrode was monitored when resting the electrode with 100% state-of-charge (SOC) in these solutions.

FIG. 9. Cycling stability of the KNiHCF electrode in various solutions at 2 C rate. a, 1 M KCl solution. b, 1 M NaCl solution. c, 1 M NH₄Cl solution. d, synthetic wastewater (sww). e, manure wastewater with a pH of ˜7. f, manure wastewater with a pH of ˜9.

FIG. 10. Cyclic voltammograms of the KNiHCF electrode in various solutions at 1 mV s⁻¹. Cyclic voltammograms of the KNiHCF RR electrode in 1 M NaCl, 1 M KCl, 1 M NH₄Cl, and synthetic wastewater (sww, 0.50 M NH₄Cl+0.183 M KHCO₃+0.146 M NaHCO₃) at 1 mV s⁻¹.

FIG. 11. Cyclic voltammograms of the KNiHCF electrode in synthetic wastewater and manure wastewater at 5 mV s⁻¹. Cyclic voltammograms of the KNiHCF electrode were first measured in synthetic wastewater (1) and then in manure wastewater (2).

FIG. 12. Rate capability of the KNiHCF electrode in various solutions. The capacity retention of the KNiHCF electrode was evaluated in 1 M NaCl (line 1), 1 M KCl (line 2), 1 M NH4Cl (line 3), and synthetic wastewater (line 4) at 1 C, 2 C, 5 C, 10 C, 100 C, 200 C, and 1000 C. The 1 C rate is defined as 65 mA g⁻¹ based on the capacity of KNiHCF. The current densities used here were 65, 130, 325, 650, 6500, 13000, and 65000 mA g⁻¹.

FIG. 13. Self-reduction behavior of the KNiHCF electrode in synthetic wastewater. The KNiHCF electrode was charged to 0.9 V vs. SCE (1.141 V vs. SHE) at 2 C rate (130 mA g⁻¹) in synthetic wastewater (line 1) and rested in the same solution for 48 hours. Then, the KNiHCF electrode was discharged to −0.05 V vs. SCE (0.191 V vs. SHE) in synthetic wastewater at 2 C rate (line 2). The capacity of the KNiHCF electrode after 48-hour resting was 36.5 mAh g⁻¹, and the initial capacity at 2 C rate was 51.8 mAh g⁻¹. The self-reduction rate (or self-discharge rate) of the RR electrode was 0.6% per hour when the electrode was charged in synthetic wastewater at 2 C rate.

FIG. 14. NH₄⁺ recovery from synthetic wastewater. a, Schematic illustration of the NH₄⁺ recovery processes using the KNiHCF electrode from synthetic wastewater. Each recovery cycle includes two steps. In the first step, the NH₄⁺ uptake into RR electrode is paired with OER at the Pt anode in synthetic wastewater (left cell). In the second step, the NH₄⁺ release from RR electrode is paired with HER at the Pt cathode in 0.1 M Li₂SO₄ solution (pH ˜1.3) (right cell). b, Chronopotentiometry profiles of the KNiHCF and Pt electrodes in the NH₄⁺ uptake and release steps. c, Concentration changes and ion balance of NH₄⁺ , Na⁺, and K⁺ over the five-cycle recovery process from synthetic wastewater. Nearly 100% NH₄⁺ removal was achieved after the five-cycle recovery process. The nutrient (NH₄⁺+K⁺) selectivity was ˜100% in the initial three cycles when the concentrations of nutrient ions were not too low compared to that of Na⁺.

FIG. 15. Electrochemical performance of the KNiHCF electrode in the five-cycle recovery process from synthetic wastewater. a, Potential of the KNiHCF RR electrode paired with HER (RR oxidation, curves 2) and OER (RR reduction, curves 1) during the five-cycle recovery process. b, The charges passing through the RR electrode during the five-cycle recovery process (RR reduction, 1; RR oxidation, 2).

FIG. 16. Concentrations of various cations in the recovered solutions over the five-cycle recovery process. The concentrations of recovered ions (NH₄⁺, K⁺, Na⁺) were analyzed by IC. The five-cycle recovery process was conducted in synthetic wastewater, which corresponded to the NH₄⁺ recovery processes in FIG. 14.

FIG. 17. Faradaic efficiency (FE) and ion selectivity during the five-cycle recovery process from synthetic wastewater. a, FE of the detected cations (NH₄⁺, K⁺, and Na⁺) over the five-cycle recovery process. b, NH₄⁺ /K⁺ and NH₄⁺/Na⁺ ion selectivity over the five-cycle process.

FIG. 18. NH₄⁺ loss during the electrochemical NH₄⁺ recovery process. a, Electrochemical configuration used to study the NH₄⁺ loss in the recovery process from synthetic wastewater. The H-cell had two chambers separated with a Selemion AMV anion-exchange membrane (Asahi Glass Co.), one for the reduction of the KNiHCF RR electrode that could intercalate cations and the other for oxidation reactions at the Pt anode. b, Concentrations of cations in both chambers after the reduction of RR and the paired anodic oxidation reactions. In principle, the reduction of the RR electrode could uptake NH₄⁺, and we should observe the concentration decrease of NH₄⁺ in the RR chamber. The anion-exchange membranes allow the transport of anions rather than cations to maintain the charge balance. Assuming no NH₄⁺ loss occurs in the Pt chamber, in that case, the anodic reactions at the Pt electrode should be the oxygen evolution reaction, and we should observe the nearly changeless concentration of NH₄⁺. The apparent NH₄⁺ loss in our results indicates that the side reactions involved in NH₄⁺ occurred during the electrochemical recovery process.

FIG. 19. NH₄⁺ removal and cation balance during the three-cycle recovery process from synthetic wastewater. a, Concentration changes of NH₄⁺, Na⁺, and K⁺ and NH₄⁺ over the three-cycle NH₄⁺ recovery process. b, NH₄⁺ balance over the three-cycle recovery process. c, The quantities of ions removed from synthetic wastewater.

FIG. 20. Electrochemical performance of the KNiHCF electrode during the three-cycle recovery process from synthetic wastewater. a, Potential of the KNiHCF electrode paired with OER (RR reduction, curves 1) and HER (RR oxidation, curves 2) during the three-cycle recovery process. b, Charges passing through the RR electrode in the recovery process (RR reduction, 1; RR oxidation, 2).

FIG. 21. FE and ion selectivity during the three-cycle NH₄⁺ recovery process from synthetic wastewater. a, FE based on the detected cations (NH₄⁺, K⁺, and Na⁺) over the three-cycle recovery process. b, NH₄⁺ removal from synthetic wastewater and the nutrient (NH₄⁺ and K⁺) selectivity over Na⁺. c, NH₄⁺ /K⁺ and NH₄⁺ /Na⁺ ion selectivity over the three-cycle recovery process.

FIG. 22. Capacity of the KNiHCF electrode over the recovery processes in synthetic wastewater. The capacity of the KNiHCF electrode was measured before (line 1) and after the 5-cycle and 3-cycle recovery processes (line 2) in synthetic wastewater at 1 C rate (65 mA g⁻¹). The potential window was from −0.05 V to 0.9 V vs. SCE (0.191 V to 1.141 V vs. SHE).

FIG. 23. NH₄⁺ and K⁺ recovery from manure wastewater. a, Schematic illustration of the NH₄⁺ and K⁺ recovery process using the KNiHCF RR electrode from manure wastewater. Three parallel recovery experiment cycles were conducted on three manure wastewater samples (runs 1, 2, and 3). Each recovery run includes two steps: the NH₄⁺ and K⁺ uptake and reduction of RR driven by the oxidation of organic matter in manure wastewater (left cell) and NH₄⁺ release and oxidation of the RR paired with HER in 0.1 M Li₂SO₄ solution (PH ˜2) (right cell). b, Potential of the KNiHCF RR electrode in the NH₄⁺ uptake and release steps. c, Concentration changes and ion balance of NH₄⁺, Na⁺, and K⁺ over the three recovery runs from manure wastewater. The nutrient selectivity is ˜100% over the three runs. d, Initial COD and COD removal over the three NH₄⁺ recovery runs. e, Capacity retention of RR, NH₄⁺ removal, COD removal, and nutrient selectivity throughout 50 recovery runs from manure wastewater (the values presented are for every 5 runs).

FIG. 24. Optimization of the capacity of the KNiHCF RR electrode in the NH₄⁺ recovery processes from manure wastewater. a, Concentration changes of NH₄⁺ in 2 mL manure wastewater when using the RR electrodes with different capacities. The concentration of NH₄⁺ in manure wastewater did not change when no RR electrode was added. When the RR electrodes with different mass loadings (300 mg, 600 mg, and 1200 mg) were used for recovery, the concentration changes of NH₄⁺ in 2 mL manure wastewater were similar, with 60%, 62%, and 68% NH₄⁺ removal from low to high capacities. b, RR electrodes with different capacities and the corresponding NH₄⁺ removals in the recovery processes. The theoretical charge to recover NH₄⁺ ions from manure wastewater is defined as QN (96.5 C for 2 mL manure wastewater). Three conditions using electrodes with ˜0.5 QN, 1 QN, and 2 QN capacities were compared. After the 24-hour spontaneous recovery, the RR electrodes showed similar NH₄⁺ removals, although their mass loadings differed. These results indicate that the KNiHCF RR electrode with a higher capacity could achieve a higher removal but with obvious diminishing improvement when the capacity exceeds 0.5 QN.

FIG. 25. FE and ion selectivity of the KNiHCF electrode in the NH₄⁺ recovery processes from manure wastewater. a, FE of the detected cations (NH₄⁺ , K⁺, and Na⁺) over the NH₄⁺ recovery processes from manure wastewater. The FE was above 100% over several repeatable recovery processes, possibly because of the co-adsorption of organic matter and inorganic ions during the spontaneous NH₄⁺ uptake process. b, Comparison of NH₄⁺ /K⁺ and NH₄⁺ /Na⁺ selectivity in the recovery processes from synthetic wastewater and manure wastewater.

FIG. 26. Cyclic voltammograms of different electrodes in synthetic wastewater and manure wastewater at 10 mV s⁻¹. Cyclic voltammograms of the Pt plate, carbon cloth (ELAT), and Ti mesh (150 mesh) in a, synthetic wastewater and b, manure wastewater. The dashed line is the position of the redox peak of the KNiHCF RR electrode in manure wastewater. The Pt plate, carbon cloth, and Ti mesh electrodes showed much more prominent oxidation peaks in manure wastewater than in synthetic wastewater. Although the current densities of these oxidation peaks varied, the shapes and positions of the peaks were similar. The oxidation peak in manure wastewater occurs at ˜0.62 V versus SHE, lower than the redox potential of the KNiHCF electrode at ˜0.69 V versus SHE.

FIG. 27. Electrochemical behaviors of the KNiHCF electrode in synthetic and manure wastewater with model organic molecules. a, Chemical structures of model organic matter, glucose, glycine, and formate and the classes of chemicals they represent in parentheses. b, Cyclic voltammograms of Pt electrode in manure wastewater with or without added 50 mM glucose, glycine, and formate, at 10 mV s⁻¹. c, Self-reduction behaviors of the KNiHCF electrode (a total mass of 100 mg) in synthetic wastewater (sww), sww+50 mM glucose, sww+50 mM glycine, sww+50 mM formate, and sww+50 mM glucose, glycine, and formate. The potential of the KNiHCF electrode was monitored when resting the electrode with 100% state-of-charge (SOC) in these solutions. Based on previous reports on similar waste streams, manure wastewater should include urea, amines, amino acids and derivatives, carbohydrates, imidazolines, lipids, and organic acids. Among these organic compounds, it is generally understood that the classes of organic molecules that contain hydroxyl, aldehyde, or amine groups are usually chemically or electrochemically active under mild conditions. A few readily accessible organic compounds were chosen that show relatively high concentrations in urine and feces: glucose, glycine (hydrolysis product of Hippurate), and formate, as the model organic matter representing the general carbohydrates, amino acids and derivatives, and organic acids, respectively. The organic molecules were directly dissolved in synthetic or manure wastewater. For example, to prepare “10 mL sww+50 mM glucose, glycine, and formate”, 0.5 mmol glucose, 0.5 mmol glycine, and 0.5 mmol potassium formate were dissolved in 10 mL synthetic wastewater.

FIG. 28. Charges passing through the RR electrode and needed for COD removal during the NH₄⁺ recovery processes from manure wastewater. Chemical oxygen demand (COD) indicates the amount of oxygen needed to oxidize the organic matter in a quantity of wastewater. The Coulombic efficiency, defined as the ratio of the charges passing through the RR (C_{RR}) to the charges needed for COD removal (C_{COD}), is also displayed.

FIG. 29. Electrochemical performance of the KNiHCF electrode during the NH₄⁺ recovery processes from manure wastewater. a, Potential of the KNiHCF electrode in manure wastewater (RR reduction) and the recovered solutions (RR oxidation, lines 2) during the 3-run recovery process. b, Charges passing through the RR electrode during the 3-run recovery process.

FIG. 30. COD removal from manure wastewater in a four-cycle recovery process from the same manure wastewater sample. a, Initial COD and COD removal over the 4-cycle NH₄⁺ recovery process. b, CE [the ratio of the charges passing through the RR electrode (C_{RR}) to the charges needed for COD removal (C_{COD})] over the 4-cycle NH₄⁺ recovery process. A KNiHCF electrode with a mass loading of 1200 mg was used to uptake NH₄⁺ repeatedly from 2 mL manure wastewater. Considering that 0.1˜0.2 mL manure wastewater was required for COD analysis, 1 mL manure wastewater was used for cycles 2, 3, and 4. After each cycle, nearly 50 mg (NH₄)₂SO₄ was added to manure wastewater to maintain the cation concentrations. Accumulated charges were calculated by summing up the charges of each cycle. For example, the accumulated charge for cycle 2 was the total charge of cycle 1 and cycle 2.

FIG. 31. The rate of NH₄⁺ uptake using the KNiHCF RR electrode at different operation conditions. Here Q_{NH4+} is the minimal charge to recover NH₄⁺ in manure wastewater. Q_{RR} is the charge of the RR electrode.

FIG. 32. Simultaneous NH₄⁺ recovery from manure wastewater and H₂ production using the KNiHCF RR electrode. a, Schematic illustration of the electrochemical configuration for NH₄⁺ release and H₂ production. b, Chronopotentiometry curves of the electrodes in the NH₄⁺ release and HER processes. c, Changes of ions (mmol) in manure wastewater and the recovered solution. d, PXRD pattern of the recovered salts dried from 25 mL recovered solution, in comparison with standard PXRDs of various compounds. Inset is the photograph of the recovered salt in a 20 mL vial with a mass of 0.6137 g.

FIG. 33. Collection of the H₂ gas during the NH₄⁺ release and H₂ production process. a, Collection of H₂ gas using the water replacement method. b, Volume of gas before (top panel) and after the H₂ production (bottom panel). The volume of the produced H₂ gas is 46.0±1.2 mL (53.5±0.6 mL−7.5±0.6 mL). Based on the ideal gas law (pV=nRT), the molar volume of the ideal gas at room temperature (25° C.) is 24. 47 L mol⁻¹. The theoretical volume of the produced H₂ gas is 45.65 mL, which was calculated based on the passing charge of 360 C. Therefore, the FE during the electrochemical processes was 100.7±2.6%, which was calculated based on the ratio of the volume of the produced H₂ gas to the theoretical volume of the produced H₂ gas.

FIG. 34. Simultaneous NH₄⁺ recovery and H₂O₂ production enabled by the KNiHCF RR. a, Schematic illustration of the electrochemical configuration for NH₄⁺ release and H₂O₂ production in a two-compartment H-cell separated by a glass frit. b, Cyclic voltammograms of the Fe-CNT electrode in O₂-saturated 0.5 M K₂SO₄ solution at 10 mV s⁻¹ and the corresponding potential-dependent Faradaic efficiency for H₂O₂ production. c, The accumulation of H₂O₂ in O₂-saturated 0.5 M K₂SO₄ solution in the H-cell at 45 mA during the process of NH₄⁺ release. d, NH₄⁺ balance over the one-cycle and two-cycle NH₄⁺ recovery processes from manure wastewater. e, Left axis: concentrations of recovered NH₄⁺ and produced H₂O₂, Right axis: the Faradaic efficiency of H₂O₂ production (1) and NH₄⁺ removal (2) over the one-cycle and two-cycle recovery processes. The current H₂O₂ production was 45 mA during all processes. f, PXRD pattern of the recovered salts dried from 5 mL recovered solution in the RR chamber (14 mL in total), in comparison with standard PXRDs of various compounds. Inset is the photograph of the recovered salts with a mass of 0.658 g in a 20 mL vial.

FIG. 35. Electrochemical stability of H₂O₂ in various electrolytes. Chronoamperometry (CA) curves of the Fe-CNT electrode were collected in Ar-saturated 1 M KCl (line 1), 1 M KCl+1000 ppm H₂O₂ (line 2), 1 M NH₄Cl (line 3), and 1 M NH₄Cl+1000 ppm H₂O₂ (line 5) solutions. The applied potential on the Fe-CNT electrode was −0.554 V vs. SCE (0.100 V vs. RHE, pH=7). The CA curve of the Fe-CNT electrode was also collected in O₂-saturated 1 M NH₄Cl solution (line 4) to confirm its H₂O₂-production activity. The mass loading of the Fe-CNT electrode was ˜1 mg, and the area of the electrode area was 2 cm².

FIG. 36. Electrochemical H₂O₂ production in various solutions using the Fe-CNT electrode. a, Cyclic voltammograms of the Fe-CNT electrode at 50 mV s⁻¹ in O₂-saturated 1 M KCl (line 1), 1 M KCl+1 M NH₄Cl (line 2), and 1 M NH₄Cl (line 3). b, CA curves of the Fe-CNT electrode collected in O₂-saturated solutions at different applied potentials (0.00, 0.10, and 0.20 V vs. RHE, pH=7). c, FE of the Fe-CNT electrode for H₂O₂ production in O₂-saturated 1 M KCl, 1 M KCl30 1 M NH₄Cl, and 1 M NH₄Cl at different applied potentials (0.00, 0.10, and 0.20 V vs. RHE, initial pH=7).

FIG. 37. Chronopotentiometry curves of the Fe-CNT electrode in the O₂-saturated 0.5 M K₂SO₄ solution. a, Chronopotentiometry curves at 45 mA with a H₂O₂ test conducted when a charge of 50 C was passed. b, Chronopotentiometry curves with a H₂O₂ test taken only after a charge of 450 C was passed. The volume of the 0.5 M K₂SO₄ solution was 20 mL.

FIG. 38. Electrochemical decomposition of H₂O₂ by the KNiHCF electrode. a, Photograph of gas bubbling (H₂O₂ decomposition) when collecting linear scanning voltammetry (LSV) curve of the KNiHCF electrode. b, LSV curve of the KNiHCF electrode in the 1 M KCl+1000 ppm H₂O₂ solution at 0.5 mV s⁻¹. Lots of bubbles were observed when the scanning potential was within the shaded region.

FIG. 39. H₂O₂ accumulation paired with the oxidation of KNiHCF electrode in the undivided cells. a, H₂O₂ accumulation paired with the oxidation of KNiHCF electrode in the O₂-saturated 1 M NH₄Cl solution. b, H₂O₂ accumulation paired with the oxidation of KNiHCF electrode in the O₂-saturated 1 M KCl solution. The theoretical concentration of the produced H₂O₂ was controlled by the corresponding charges passing through the KNiHCF electrode. The difference between the theoretical and actual concentrations of H₂O₂ resulted from the electrochemical decomposition of H₂O₂ at the KNiHCF electrode.

FIG. 40. COD removal from the manure wastewater during the simultaneous NH₄⁺ recovery and electrochemical H₂O₂ production. a, Initial COD and COD removal over the 3-run NH₄⁺ recovery and H₂O₂ production process. b, CE [the ratio of the charges passing through the RR electrode (C_{RR}) to the charges needed for COD removal (C_{COD})] over the 3-run NH₄⁺ recovery and H₂O₂ production process.

FIG. 41. Cation balance during the simultaneous NH₄⁺ recovery and electrochemical H₂O₂ production. a, Removed cations in 10 mL manure wastewater over the 3-run 1-cycle recovery process. b, Recovered cations over the 3-run 1-cycle recovery process. c, Increased amount of K⁺ in the RR and H₂O₂ chambers over the 3-run 1-cycle recovery process.

FIG. 42. Electrochemical performance of the KNiHCF electrode during the simultaneous NH₄⁺ recovery and electrochemical H₂O₂ production process. a, Cell voltages over the 3-run NH₄⁺ recovery and H₂O₂ production process. b, Chronopotentiometry curves of electrodes at 45 mA and the iR drop from the electrochemical configuration over the 3-run recovery and production process.

FIG. 43. Electrochemical performance of the KNiHCF electrode in the 2-cycle simultaneous NH₄⁺ recovery and H₂O₂ production process. a, Chronopotentiometry curves of electrodes at 45 mA and the iR drop from the electrochemical configuration over the 2-cycle recovery and production process. b, Changes of ions in manure wastewater and recovered solution over the 2-cycle recovery and production process. c, COD removal over the 2-cycle process. d, Charges passing through the RR electrode and needed for COD removal during the 2-cycle NH₄⁺ recovery and H₂O₂ production process.

FIG. 44. Capacity of the KNiHCF electrode over the NH₄⁺ recovery and H₂O₂ production processes. The capacity of the KNiHCF RR electrode was measured before (line 1) and after the 3-run 1-cycle and a 2-cycle NH₄⁺ recovery and H₂O₂ production processes (line 2 in synthetic wastewater) at 45 mA. The potential window was from −0.05 V to 0.9 V vs. SCE (0.191 V to 1.141V vs SHE).

### DETAILED DESCRIPTION

Pressure to protect the environment from the effects of greenhouse gas emissions and water contamination generated by livestock manure motivates the development of new approaches to reduce the environmental impact of livestock and improve sustainability. Effective approaches to recover nutrients, especially ammonium (NH₄⁺) and potassium (K⁺) ions, from manure wastewater to produce fertilizer are needed.

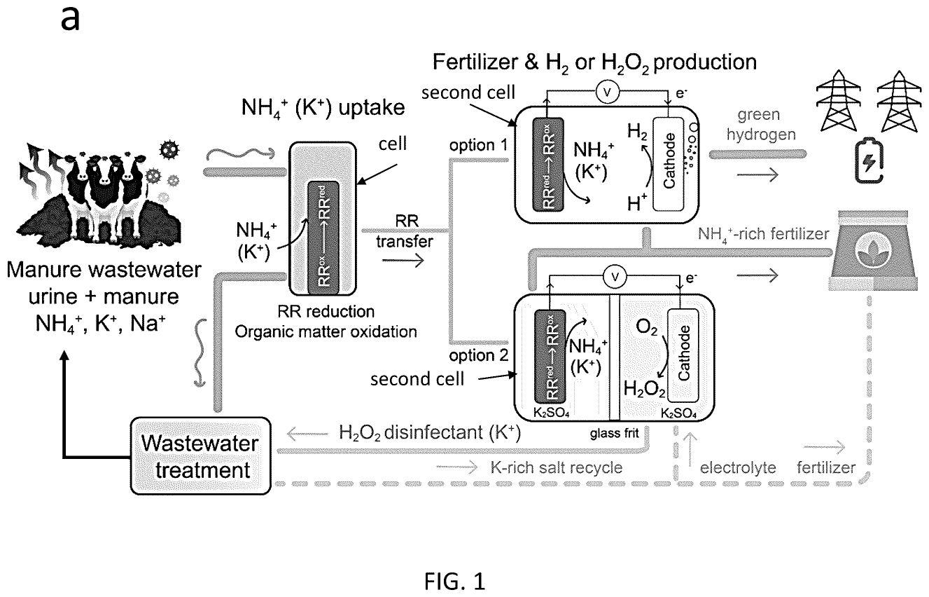

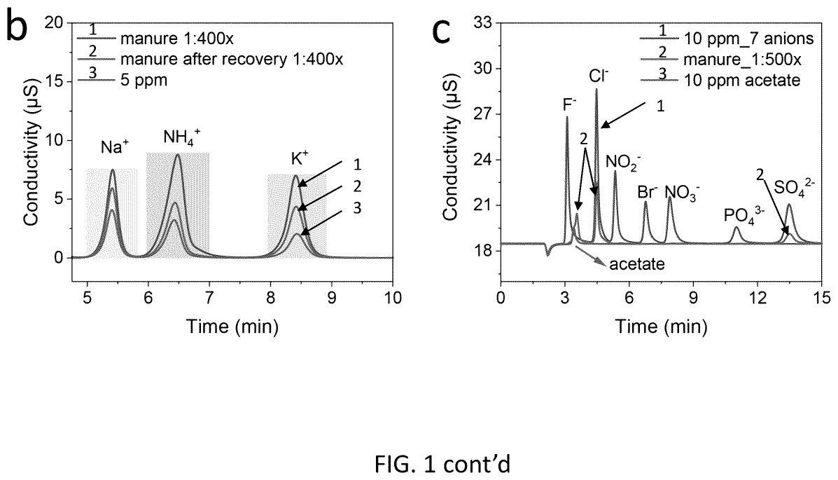

Disclosed herein is an electrochemical strategy to achieve ammonium (NH₄⁺) and/or potassium (K⁺) ion recovery and electrochemical synthesis using open framework materials as ion-selective redox materials to mediate the process. In this new approach, ammonium and potassium ions can be recovered from manure wastewater and utilized to generate H₂ or H₂O₂ (FIG. 1a). The technology disclosed herein allows for distributed electrochemical resource recovery and on-demand electrochemical manufacturing can improve agricultural sustainability. The examples demonstrate the integration of NH₄⁺ and K⁺ recovery with an electrosynthesis system and co-production of fertilizers and value-added chemicals using the open framework redox materials, air, electricity, and manure wastewater.

Manure having high nitrogen, phosphorous, and potassium content is prized as a fertilizer. A method is disclosed herein for recovering nutrient ions from manure wastewater. Additionally, and alternatively, the method may be used to recover K⁺ ions from manure wastewater. The manure wastewater can be a heterogeneous mixture. The manure wastewater can be a combination of feces and urine obtained from farm animals (e.g., cows, horses, pigs, goats, sheep, poultry) or from human waste sources. The manure wastewater can also be a digestate from any of the various digestion processes commonly used in the general treatment of manure. The manure wastewater may include additional water that is combined with the manure waste. As a byproduct of living organisms, the manure wastewater may include organic matter comprising organic carbon. For example, the manure wastewater may include bacterial biomass, protein or other nitrogenous matter, carbohydrates (e.g., cellulose) and undigested plant matter, fats and other lipophilic matter as well as other organic matter. A variety of cations and anions may be found within the manure wastewater. The cations may include for example. NH₄⁺ , Na⁺, K⁺, Mg²⁺, and Ca²⁺. The anions may include for example, Cl⁻, OH⁻, NO₃_{^{−}}, CO₃²⁻, HCO₃_{^{−}}, HPO₄²⁻, H₂PO₄_{^{−}}, and HSO₄_{^{−}} among others.

The method for recovering nutrient ions from manure wastewater can include contacting the manure wastewater with an ion-selective redox material. In one embodiment, the open framework materials can be a three-dimensional array of metal ions bridged by non-metal ions. In one example, the ammonium-ion selective redox material can be a Prussian Blue analog, or a metal hexacyanoferrate. The chemical structure of the Prussian Blue analog is characterized by the general structural formula: AₓM_{y}[Fe(CN)₆]·nH₂O, with the specific x, y, z and n parameters and the type of monovalent cation (A=K⁺, Na⁺, NH₄⁺), and a bivalent transition metal cation (M=Fe²⁺, Ni²⁺, Co²⁺, Mn²⁺, Cu²⁺, Zn²⁺, etc.). In one specific example, the ammonium-ion and potassium-ion selective redox material can be potassium nickel hexacyanoferrate. In another specific example, the ammonium-ion selective redox material can be copper hexacyanoferrate.

The ammonium-ion and potassium-ion selective redox material can have a three-dimensional structure with ionic channels, where the ionic channels are interconnected cavities or pores within the three-dimensional structure. The ionic channels can have an effective diameter, or pore size, ranging between 0.3 nm to 2 nm. The ionic channels can be occupied by hydrated ions. The hydrated ions may be bound in the ionic channels by electrostatic attraction. For example, cations may be bound within an ionic channel having a negatively charged component. In another example, anions may be bound within an ionic channel having a positively charged component. The ionic channels can be large enough for the hydrated ions to exchange and move freely through the channels when the ammonium-ion and potassium-ion selective redox material is in contact with a liquid solution.

Contacting the manure wastewater with the ion-selective redox material can reduce the ion-selective redox material by electron transfer to form a reduced material. In an aspect, the manure wastewater is capable of reducing the ammonium-ion selective redox material by transferring one or more electrons to the ammonium-ion selective redox material upon contact. For example, organic material (e.g., organic carbon components) in the manure wastewater can supply electrons to reduce the ion-selective redox material. Additionally, and alternatively, an electrode can be used to supply electrons to reduce the ion-selective redox material. Other reducing agents that can be added can include formic acid, glucose, or glycine.

The reduced material can have ionic channels similar in shape and structure to those found in the ion-selective redox material. However, the reduced material may have ionic channels with electrostatic properties that are different from those of the ion-selective redox material due to the addition of electrons. For example, the reduction of the ion-selective redox material can add negative charges to the atoms along the sides of the ionic channels. The ionic channels of the reduced material may have pore sizes that are different from the ion-selective redox material.

The reduced material can spontaneously take up nutrient ions from the manure wastewater to form an ion-loaded material. In one example, the reduced material spontaneously can take up select ions into the ionic channels. In other words, the pore size and/or electrostatic potential of the ionic channels in the reduced material can be configured to preferentially host specific ions over other ions. In one example, the reduced material can take up NH₄⁺ or K⁺ ions preferentially over other ions (e.g., Na⁺). By preferentially taking up NH₄⁺ or K⁺ ions into the ionic channels, the reduced material can effectively separate NH₄⁺ or K⁺ ions from a mixture and store the ions until they can be released at a specified time and place, where the NH₄⁺ or K⁺ ions can be collected and utilized.

The method for recovering ions from manure wastewater can include applying a current to the ion-loaded material. In an aspect, applying current to the ion-loaded material can reduce the ion-loaded material. In another aspect, applying current to the ion-loaded material can oxidize the ion-loaded material. Oxidation or reduction of the ion-loaded material changes the oxidation state of the ionic channels and thus changes the capacity of the ion-loaded material to host ions. For example, upon oxidation, the ion-loaded material can release any cations that are loosely bound in the ionic channels upon oxidation. In one specific example, applying the current to the ion-loaded material oxidizes the ion-loaded material and releases NH₄⁺ ions from the ion-loaded material. In another example, the ion-loaded material can release K⁺ ions upon oxidation. Releasing the ions from the ion-loaded material allows the ions to be utilized.

The method for recovering ions from manure wastewater can include coupling the oxidation of the ion-loaded material to a cathodic reaction. In other words, electrons released from the ion-loaded material upon oxidation can be consumed by a cathodic reaction occurring at the same time. In one example, the cathodic reaction is the hydrogen evolution reaction, where electrons and protons combine to form H₂. In another example, the cathodic reaction can be a two-electron oxygen reduction reaction producing H₂O₂ from O₂ and 2H⁺.

A system for treatment of manure wastewater is shown in FIG. 1a. The system can include a manure wastewater supply, at least one cell having an interior volume, and a wastewater treatment center. The manure waste supply can contain manure wastewater. Additionally, and alternatively the manure waste supply can include a conduit that directs the manure wastewater from an exterior supply to the cell. The cell includes at least one inlet and at least one outlet. The manure waste supply is fluidly coupled with the cell via the at least one inlet so the manure wastewater can flow to the interior volume.

The ion-selective redox material can be disposed within the internal volume of the cell. The ion-selective redox material can be fixed within the cell. Additionally, and alternatively, the ion-selective redox material can be removably disposed within the cell. The manure wastewater contacts the ion-selective redox material in the cell. For example, the ion-selective redox material can be submerged in manure wastewater within the cell. Upon contact with the manure wastewater, the ion-selective redox material can be reduced by organic carbon in the manure wastewater, whereupon it becomes the reduced material. As discussed above, the reduced material takes up NH₄⁺ or K⁺ ions from the manure wastewater to generate the ion-loaded material.

The cell can include at least one outlet that is fluidly coupled to the wastewater treatment chamber. The manure wastewater flows from the manure waste supply into the cell through the at least one inlet, contacts the ammonium-ion selective redox material to generate the ion-loaded material, and exits the cell through the outlet to the wastewater treatment chamber. The manure wastewater in the wastewater treatment chamber can be contacted with disinfectants or other additives. In one example, the wastewater treatment chamber can be fluidly coupled with the wastewater supply such that the manure wastewater can be recirculated through cell.

The ion-selective redox material can be incorporated into an electrode having an electrical connection outside the cell. In one example, the ion-loaded material in the cell can be incorporated into an electrode having an electrical connection outside the cell. The ion-loaded material can be an electrode coupled to the electrochemical controller as an anode. A cathode can be disposed in the cell. The anode and cathode are electrically coupled to the electrochemical controller, where the electrochemical controller is capable of applying a current to the anode and cathode, or applying a potential to the anode and to the cathode. Additionally, and alternatively, the ion-loaded material can be transferred to a second cell having a cathode disposed therein, where the ion-loaded material is electrically coupled to the electrochemical controller as an anode, and where the anode and cathode are both electrically coupled to the electrochemical controller. The electrochemical controller can apply a current such that the anode is oxidized. As the anode is the ion-loaded material, the NH₄⁺ ions can be released when the anode is oxidized.

In one example, the second cell can contain an aqueous solution of H⁺ ions. As the anode is oxidized, the electrons can be supplied to a cathodic reaction. In one example, the cathodic reaction is the reduction of H⁺ ions to H₂.

The second cell can include a separator extending across the interior volume of the second cell to form two compartments within the second cell. The separator can be a glass frit or other suitable material. The separator allows ions to pass through but prevents the mixing of the solutions inside the two compartments. In this example, the anode is disposed in one compartment while the cathode is disposed in the second compartment. The solution can include ions to maintain charge balance. As the electronic controller drives the oxidation at the anode, NH₄⁺ and/or K⁺ ions can be released from the ion-loaded material, and simultaneously oxygen can be reduced at the cathode, producing H₂O₂.

The NH₄⁺ ions and other cations, such as K⁺ ions, released from the ion-loaded material can be collected by drying the remaining solution. In on example, the NH₄⁺ ions and K⁺ ions can be used to supplement fertilizer.

The second cell can include an outlet. In one example, the outlet can be a gas outlet for directing gases out of the cell. The gas outlet can be fluidly coupled to a device that can utilize H₂ as a source of energy. In another example, the gas outlet can be fluidly coupled to a storage unit for storing H₂. In another example, the outlet can be fluidly coupled to the wastewater treatment chamber. In this example, the H₂O₂ generated by the reduction of oxygen at the cathode can be directed to the wastewater treatment chamber to act as a disinfectant to kill bacteria and pathogens.

Additionally, and alternatively, H₂O₂ can be converted to hydroxyl radicals using an advanced oxidation process such as an electro-Fenton process, to enable wastewater treatment.

### Miscellaneous

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1: Ammonium Recovery From Manure Wastewater and Electrochemical Synthesis

The present Example demonstrates ammonium recovery from manure wastewater and electrochemical synthesis of H₂ or H₂O₂ using an ion-selective redox material (FIG. 1a). Ammonium-ion selective redox materials are identified with high NH₄⁺ selectivity, suitable redox potential, and excellent stability for spontaneous NH₄⁺ uptake in manure wastewater driven by the oxidation of organic matter. NH₄⁺ recovery from both synthetic and natural manure wastewater using the electrode comprising the ammonium-ion selective redox material is systematically studied to understand the cation balances, self-reduction behaviors of the electrode, and the relationship between ion selectivity and NH₄⁺ removal over recovery processes. Paired electrochemical NH₄⁺ release with the electrosynthesis of H₂ or H₂O₂ with high Faradic efficiency is demonstrated without ion-exchange membranes. Moreover, drying recovered solutions (or wastewater treated with H₂O₂) can yield (or recycle) ammonium/potassium-rich fertilizers. Such rational design enables the demonstration of integrated NH₄⁺ recovery and electrosynthesis system and co-production of fertilizers and value-added chemicals using electrodes comprising the ammonium-ion selective redox materials, air, electricity, and manure wastewater. The integrated process holds economic potential for dairy farms and could potentially mitigate NH₃ emissions.

### Results

### Design of the Ammonium Recovery and Electrochemical Synthesis System

The integrated system for ammonia recovery and electrosynthesis includes the NH₄⁺ uptake, fertilizer production, electrochemical synthesis, and wastewater treatment processes (FIG. 1a). The system uses solid-state redox materials that can selectively transport NH₄⁺ ions and be paired with other electrochemical half reactions to enable the co-production of value-added chemicals without using membranes yet with no product crossover. These materials may be referred to redox reservoirs (RRs) because RRs allow temporary storage of electrons and ions and redirect them for different electrochemical half-reactions. Using redox materials with high NH₄⁺ selectivity may not only selectively recover NH₄⁺ nutrients from manure wastewater but also enable the simultaneous co-production of value-added chemicals in a membrane-free fashion.

As illustrated in FIG. 1a, the spontaneous oxidation of organic matter present in manure wastewater by the oxidized RR (RR^{OX}) drives the NH₄⁺ uptake process concurrent with the reduction of RR to the reduced RR (RR^{red}). Then, the RR electrode is transferred to different electrochemical cells to pair with H₂ or H₂O₂ production at the cathode, while the oxidation of RR from RR^{red} to RR^{OX} releases NH₄⁺. The NH₄⁺-selective RR can reversibly uptake and release NH₄⁺ during redox cycles and maintains the charge balance in different cells, thus achieving effective NH₄⁺ recovery. Drying the recovered solutions yields NH₄⁺-rich fertilizers. Moreover, since relatively concentrated K₂SO₄ solution is used as the supporting electrolyte for H₂O₂ production, after using the produced H₂O₂ to further disinfect the manure wastewater after NH₄⁺ recovery, such treated wastewater can be concentrated to recycle K⁺-rich salts as electrolytes or fertilizers (potash).

The manure wastewater prepared from cow feces and urine is a weakly alkaline suspension with a pH value of ˜9 and contains different inorganic ions (NH₄⁺, Na⁺, K⁺, etc.), organic species, and solid particles (see cation and anion analysis details in FIG. 1b⁻¹c, and Table 1). Given its complicated chemical compositions, the challenges of NH₄⁺ recovery lie in the competing uptake of other cations present in manure wastewater, such as Na⁺, and the stability of the RR material. Therefore, the ideal RR material should meet several criteria: high NH₄⁺ selectivity, suitable redox potential, excellent chemical and electrochemical stability in manure wastewater, fast redox kinetics, and high capacity.

TABLE 1
Chemical compostions of the manure wastewater.

| | Real manure waterwater |
|---|---|
| pH | 9.0~9.2 |
| NH₄⁺ (mM)^{[a]} | 497 ± 23 |
| Na⁺ (mM)^{[a]} | 148 ± 4.2 |
| K⁺ (mM)^{[a]} | 183 ± 8.8 |
| Cl⁻ (mM)^{[a]} | 47 ± 4.5 |
| Sulfate (mM)^{[a]} | 11 ± 0.88 |
| Total phosphate (ppm)^{[b]} | 1602 ± 28 |
| Acetate (mM)^{[a]} | <164 |
| Total nitrogen (mM)^{[b]} | 558 ± 30 |
| Nitrate (mM)^{[a]} | 0 |
| Nitrite (mM)^{[a]} | 0 |
| Total inorganic carbon (ppm)^{[c]} | 3700 ± 13 |
| Total organic carbon (ppm)^{[c]} | 6400 ± 54 |
| Chemical oxygen demand (g O₂ L⁻¹) | 24.04 ± 0.4 |

^{[a]}The concentractions of cations and anions were analyzed using IC.
^{[b]}Total phosphates and nitrogen were analyzed using the corresponding reagent sets from Hach.
^{[c]}The concentractions of the carbon sepecies were analyzed using a total organic carbon analyzer

Synthesis and Electrochemical Performance of NH₄⁺-Selective Redox Reservoirs

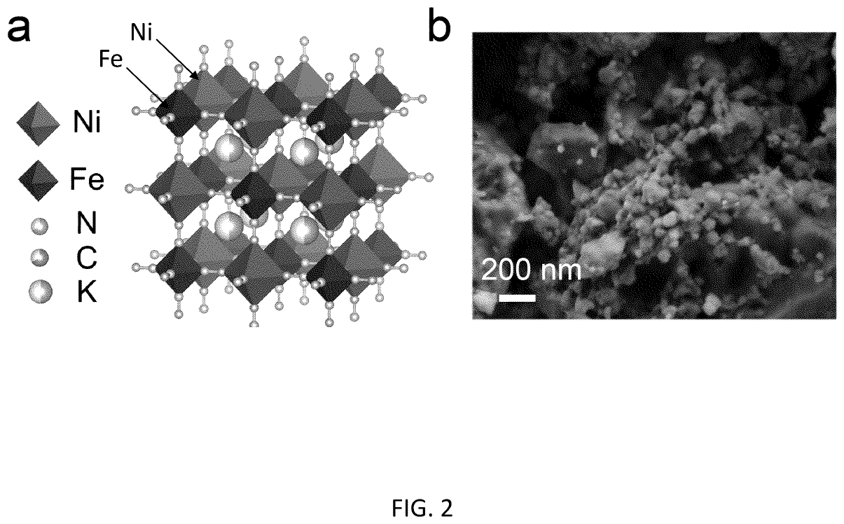

Because the Stokes radius and desolvation energy barrier of NH₄⁺ are smaller than those of common metal ions (e.g., Na⁺, K⁺, Ca²⁺, Mg²⁺), the (de) intercalation of NH₄⁺ should be intrinsically faster than other cations. Furthermore, recent progress suggests that redox materials with large ionic channels that can form non-ionic H-bonding with charge carriers may selectively accelerate the NH₄⁺ migration over other metallic cations. Following such general guidelines, we choose Ni and Cu-based Prussian Blue analogs (PBAs) with open-framework structures (FIG. 2a).

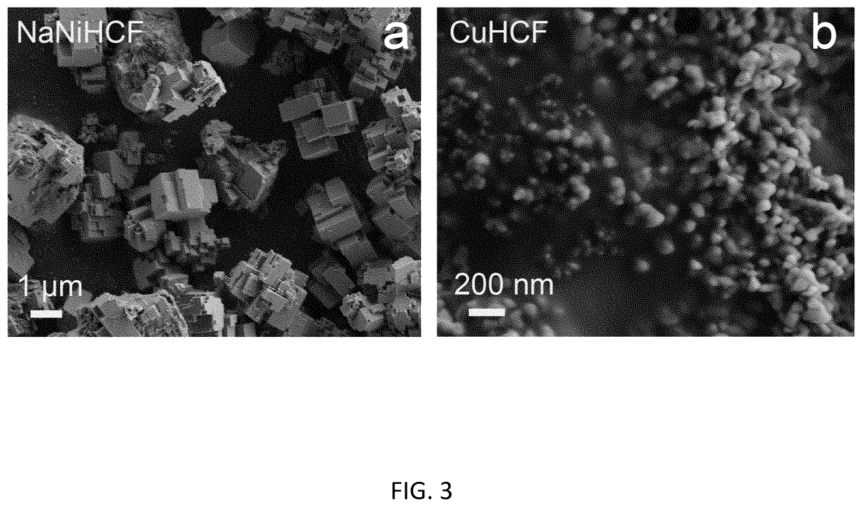

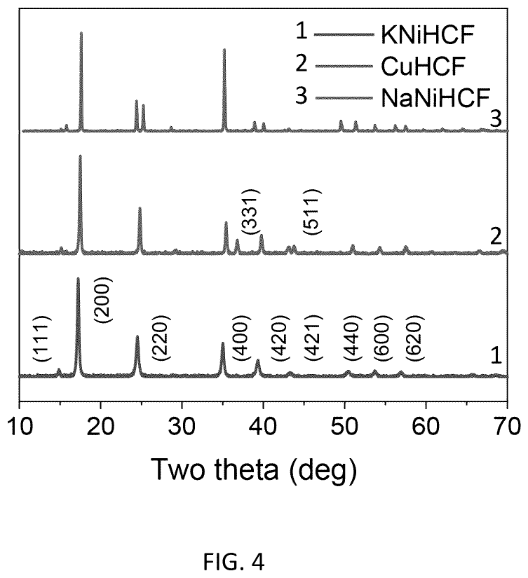

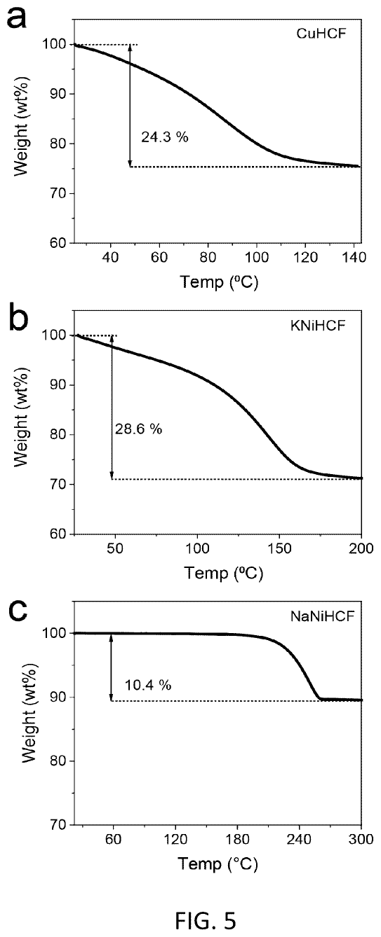

We used co-precipitation methods to synthesize various PBAs with different morphologies (see Methods), including KNiHCF nanoparticles (FIG. 2b), sodium nickel hexacyanoferrate microcubes (NaNiHCF, FIG. 3a), and copper hexacyanoferrate nanoparticles (CuHCF, FIG. 3b). Powder X-ray diffraction (PXRD) patterns of the KNiHCF and CuHCF samples (FIG. 4) display the characteristic (200), (220), and (400) diffraction peaks that match well with the standard pattern of the cubic PBA phase (JCPDS No. 52-1907). In comparison, the NaNiHCF sample has the rhombohedral structure (FIG. 4). Thermogravimetry analyses (TGA, FIG. 5) revealed the water content in these samples. CuHCF includes 24.3% water (FIG. 5a), KNiHCF includes 28.6% water (FIG. 5b), and NaNiHCF includes 10.4% water (FIG. 5c).

The element compositions were analyzed using inductively coupled plasma optical emission spectroscopy (ICP-OES, Table 2). The exact chemical formulas of the KNiHCF, NaNiHCF, and CuHCF samples were determined to be K_{0.1}Ni_{1.5}[Fe(CN)₆]·6.7 H₂O, Na_{2.1}Ni[Fe(CN)₆]·2.1 H₂O, and K_{0.06}Cu_{1.5}[Fe(CN)₆]·5.5 H₂O, respectively.

TABLE 2
Weight percentages of metal elements and water content in various PBA samples.

| RR | Na or K, | Ni or Cu, | | H₂O, | |
|---|---|---|---|---|---|
| materials^{[a]} | wt % | wt % | Fe, wt % | wt % | Chemical formula |
| KNiHCF | 0.9 | 20.7 | 13.1 | 28.6 | K_{0.1}Ni_{1.5}[Fe(CN)₆] · 6.7 H₂O |
| NaNiHCF | 13.6 | 16.6 | 15.8 | 10.4 | Na_{2.1}Ni[Fe(CN)₆] · 2.1 H₂O |
| CuHCF | 0.6 | 23.6 | 13.6 | 24.3 | K_{0.06}Cu_{1.5}[Fe(CN)₆] · 5.5 H₂O |

^{[a]}For metal elemental analysis, PBA samples were annealled in air at 600° C. for 1 h and dissolved in 5% HNO₃ at 80° C. overnight. The dissolved samples were diluted for the ICP-OES measurements.

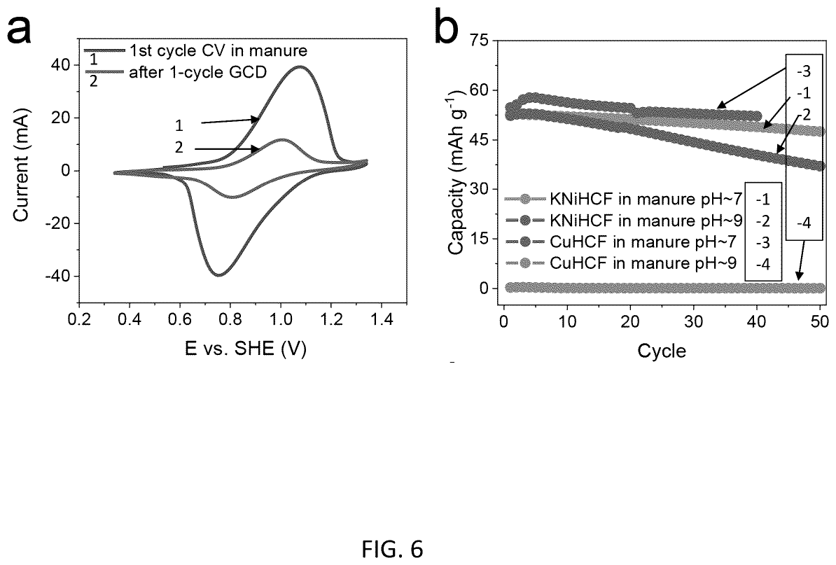

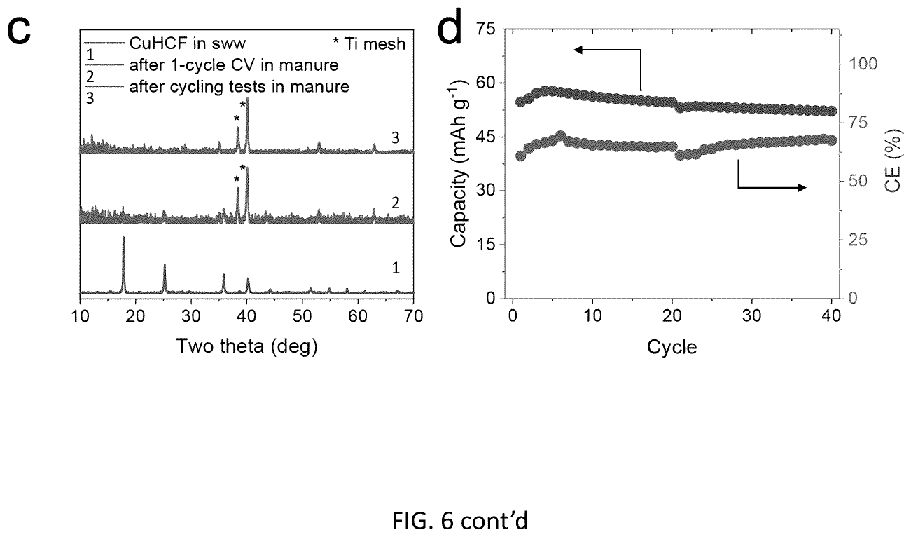

Cycling stability of these PBA electrodes was evaluated in manure wastewater. The CuHCF electrode showed near zero capacity in the first few cycles from cyclic voltammograms (CV) measurements (FIG. 6a) and galvanostatic charge-discharge (GCD) tests (FIG. 6b). PXRD patterns after cycling tests exhibited only diffraction peaks of the Ti substrate (FIG. 6c), suggesting the possible dissolution of CuHCF in manure wastewater. The capacity retention and Coulombic efficiency (CE) of the CuHCF electrode in manure wastewater with a pH of ˜7 is shown in FIG. 6d.

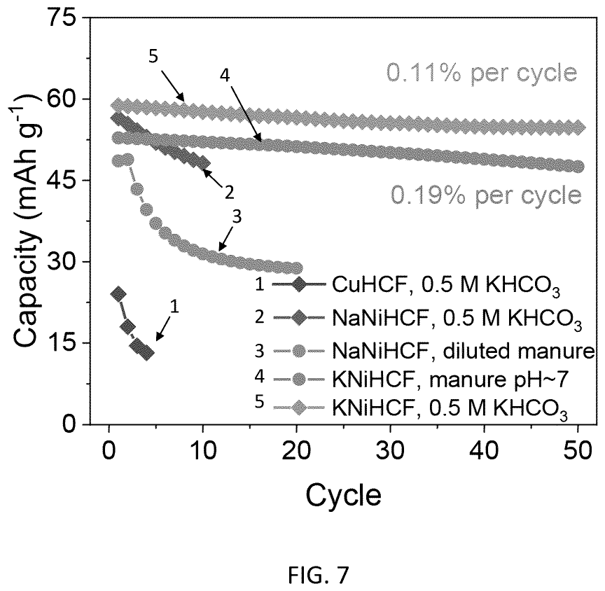

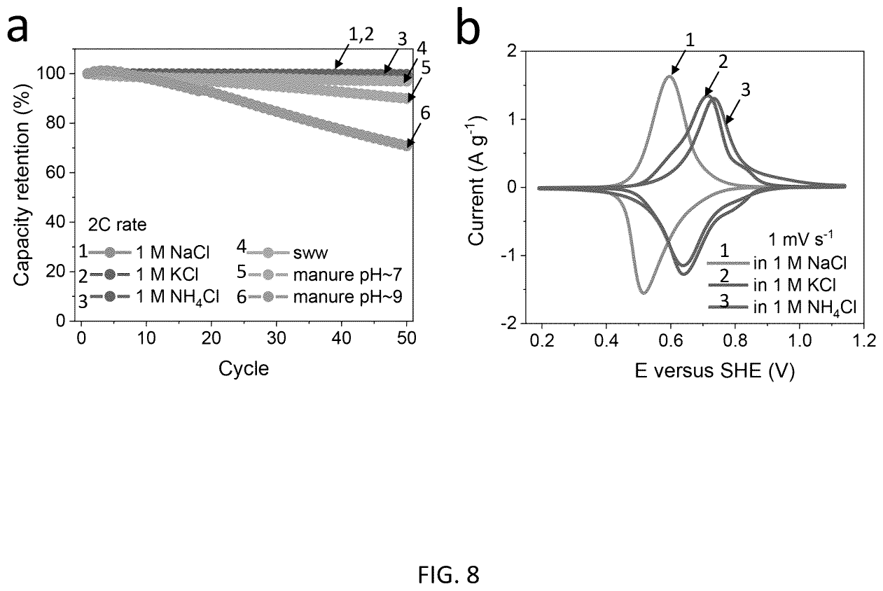

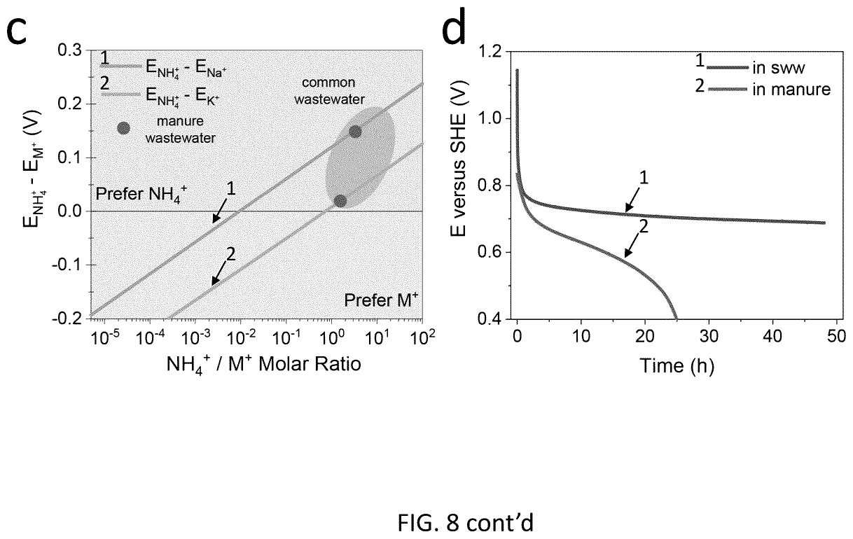

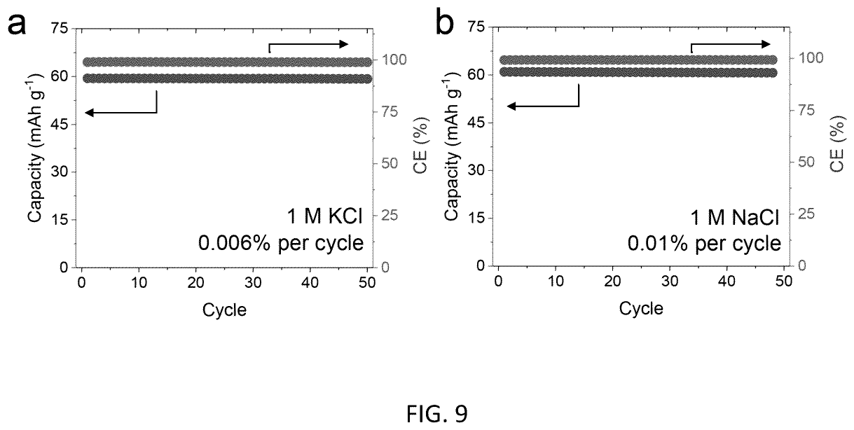

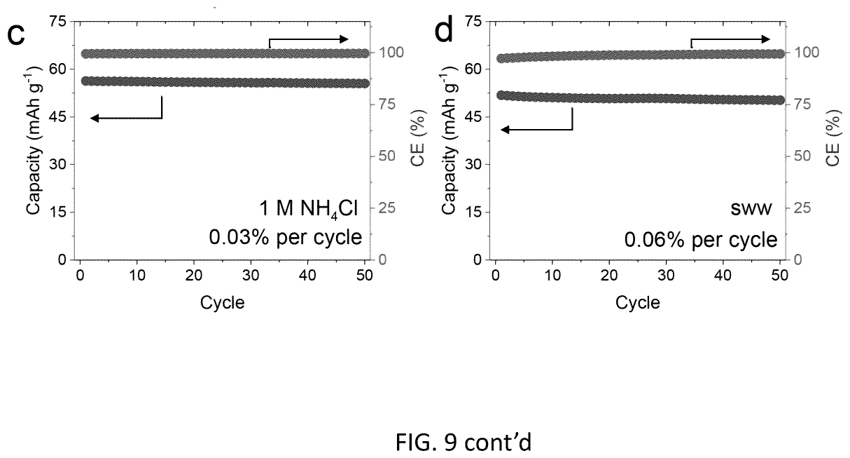

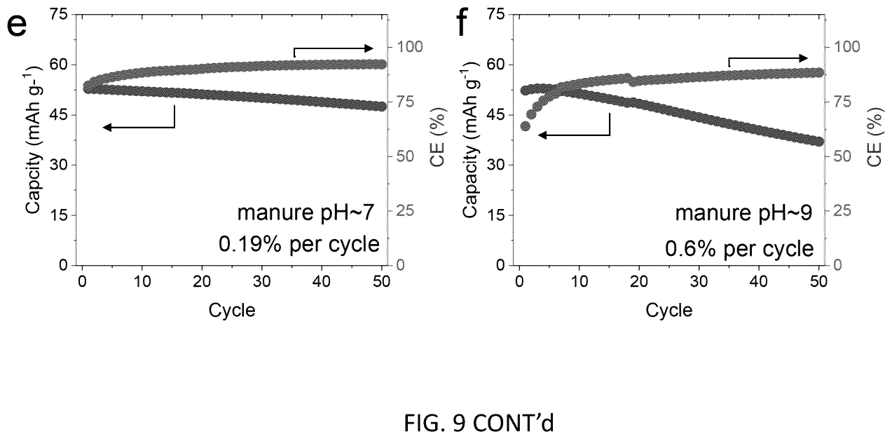

NaNiHCF and KNiHCF electrodes were measured. The NaNiHCF electrode with pre-intercalated cations showed obvious capacity decay at 2 C rate in weakly alkaline solutions (FIG. 7). Here, 1 C rate is 65 mA g⁻¹ based on the theoretical capacity. The GCD tests of the KNiHCF electrode at 2 C rate confirmed its long-term cycling stability in various solutions and even neutral manure wastewater (FIG. 8a, FIG. 9, and Table 3).

TABLE 3
Cycling stability of the various PBA
electrodes in various solutions.

| | | Capacity | Stability |
|---|---|---|---|
| Material | Solution | (mAh g⁻¹) ^{[a]} | (decay per cycle) |
| KNiHCF | 1M NaCl | 61.0 | 0.01% |
| | 1M KCl | 59.4 | 0.006% |
| | 1M NH₄ Cl | 56.3 | 0.03% |
| | Synthetic wastewater | 51.8 | 0.06% |
| | Manure, pH~7^{[b]} | 52.8 | 0.19% |
| | Manure, pH~9^{[c]} | 52.3 | 0.60% |
| | 0.5M KHCO₃ | 58.8 | 0.11% |
| NaNiHCF | 0.5M KHCO₃ | 56.5 | 1.49% |
| | Diluted manure | 48.6 | 2.51% |
| | wastewater (1:4 | | |
| | dilution) | | |
| CuHCF | 0.5M KHCO₃ | 24.1 | 12.5% |
| | Manure, pH~7 | 54.8 | 0.10% |
| | Manure, pH~9 | 0.31 | —^{[d]} |

^{[a]} The listed capacities of PBA electrodes were measured in different solutions at 2 C rate.
^{[b]}Manure wastewater with a pH of ~7 was prepared by acidifying manure wastewater (pH~9) using 3M H₂SO₄ solution.
^{[c]}Manure wastewater without further modification.
^{[d]}The capacity of the CuHCF electrode decayed to ~0 after the first GCD cycle.

Based on these results, KNiHCF was chosen as the model RR material and systematically studied its cation intercalation properties. CV profiles of the KNiHCF electrode in 1 M NaCl, 1 M

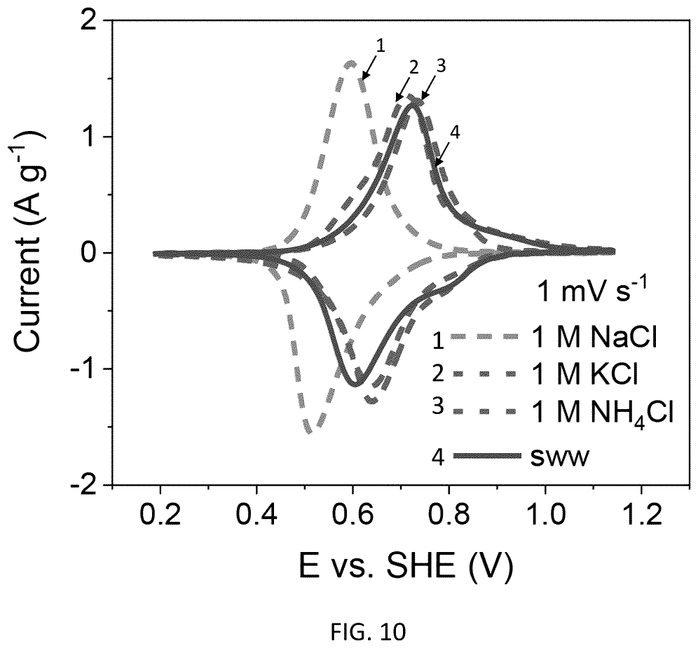

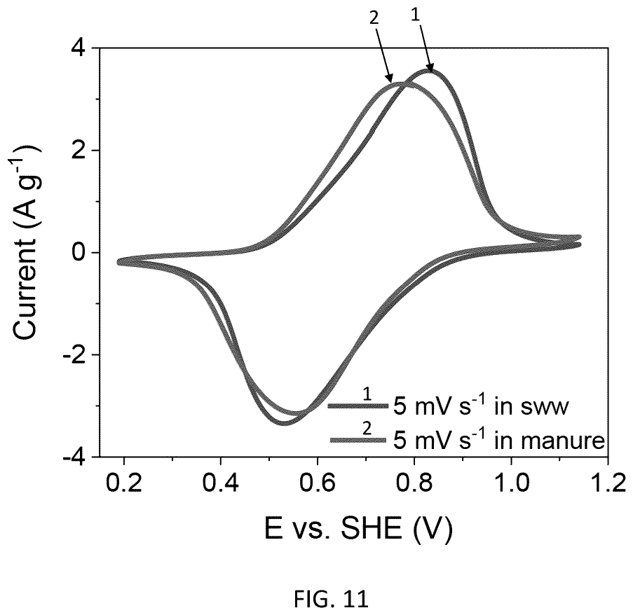

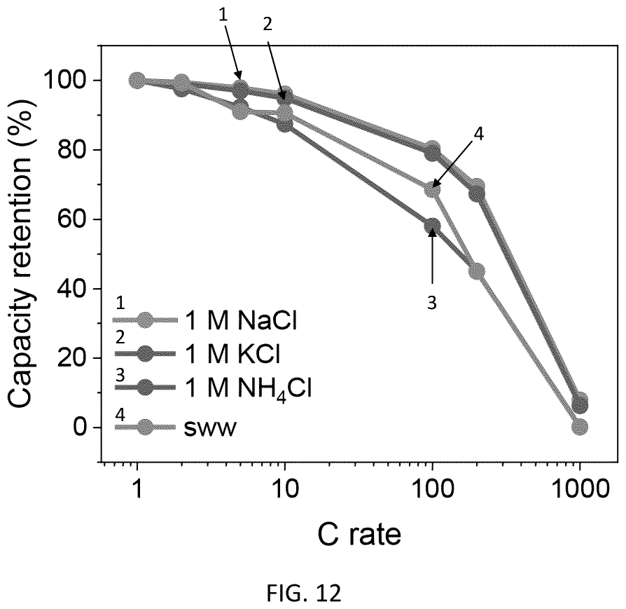

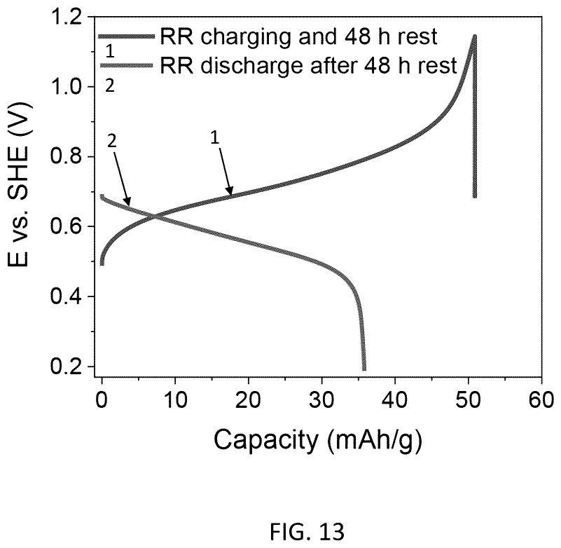

KCl, and 1 M NH₄Cl solutions at 1 mV s⁻¹ (FIG. 8b) showed reversible redox chemistry with intercalation potentials of NH₄⁺, K⁺, and Na⁺ at ˜0.686 V, ˜0.678 V, and ˜0.566 V versus standard hydrogen electrode (SHE), respectively. Based on the Nernst equation, such differences in thermodynamic driving forces (˜0.120 V for NH₄⁺/Na⁺ and ˜0.08 V for NH₄⁺/K⁺) mean that NH₄⁺ intercalation is theoretically preferred when the molar ratio of NH₄⁺/Na⁺ is greater than 9×10⁻³, or the molar ratio of NH₄⁺/K⁺ is above 0.7 (Example 2). Therefore, the KNiHCF electrode should show high selectivity for NH₄⁺ intercalation in manure and common municipal wastewater given the ranges of the molar ratios of NH₄⁺/Na⁺or K⁺ present there (FIG. 8c and Table 4). Similar CV profiles and rate capabilities of the KNiHCF electrode in synthetic wastewater (sww, 0.50 M NH₄Cl+0.183 M KHCO₃+0.146 M NaHCO₃), manure wastewater, and 1 M NH₄Cl solution (FIGS. 10, 11, and 12) were found, suggesting possibly dominated NH₄⁺ (de) intercalation in these solutions. Moreover, the KNiHCF electrode with 100% state-of-charge (SOC) was spontaneously reduced to ˜0% SOC after 24 hours, likely by the organic matter present in manure wastewater (FIG. 8d). In comparison, the KNiHCF electrode still had a 70.5% SOC after 48-hour self-reduction in synthetic wastewater (FIG. 8d and FIG. 13). Since the reduction of RR requires cation intercalation to balance the charge, all the above results suggest that the KNiHCF RR could spontaneously and selectively uptake NH₄⁺ ions from manure wastewater.

TABLE 4
Concentrations of common cations in manure waster,
urine, and various types of municipal wastewater.

| | | NH₄⁺, | Na⁺, | K⁺, | | | |
|---|---|---|---|---|---|---|---|
| Wastewater | pH | mM | mM | mM | NH₄/Na | NH₄/K | Ref |
| Our manure wastewater | 9.0 | 497.0 | 146.0 | 183.0 | 3.4 | 2.7 | This |
| | | | | | | | work |
| Pretreated human urine | 9.0 | 188.9 | 69.6 | 35.8 | 2.7 | 5.3 | ² |
| Real urine | 9.0 | 272.9 | 70.4 | 37.6 | 3.9 | 7.3 | ³ |
| Human urine | 9.2 | 392.1 | 107.4 | 58.6 | 3.7 | 6.7 | ⁴ |
| Human urine | 8.9 | 289.3 | 80.4 | 38.1 | 3.6 | 7.6 | ⁵ |
| Real livestock wastewater | 4.2 | 158.3 | 28.3 | 40.4 | 5.6 | 3.9 | ⁶ |
| Centrate from wastewater | 8.4 | 47.1 | 18.5 | 5.8 | 2.5 | 8.1 | ⁷ |
| treatment plant (WWTP) | | | | | | | |
| Centrate from WWTP | 7.6 | 84.9 | 12.0 | 2.6 | 7.1 | 32.9 | ⁸ |
| Treated wastewater from | 6.8 | 0.1 | 1.8 | 0.3 | 0.05 | 0.3 | ⁹ |
| WWTP | | | | | | | |
| Landfill leachate | 7.9 | 324.3 | 145.3 | 33.2 | 2.2 | 9.8 | ¹⁰ |

NH₄⁺ Recovery From Synthetic Manure Wastewater

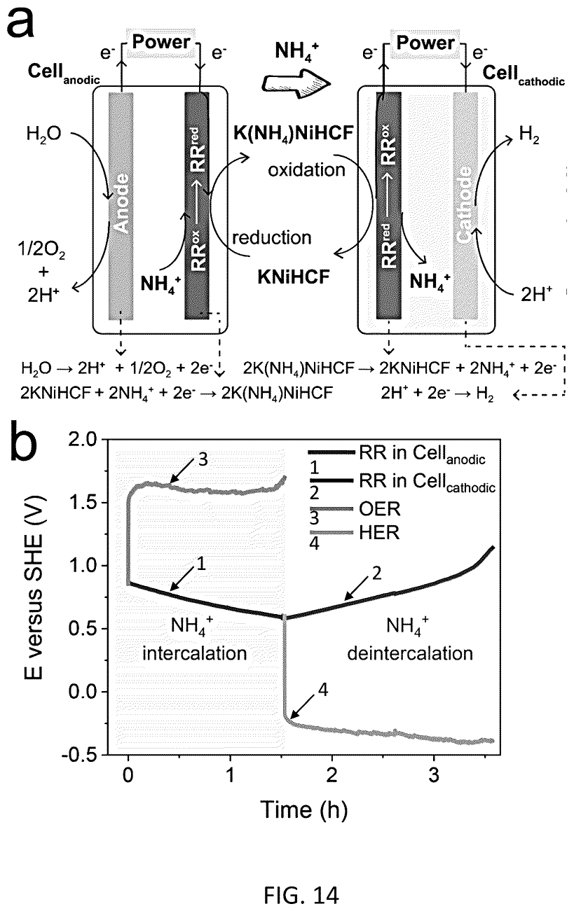

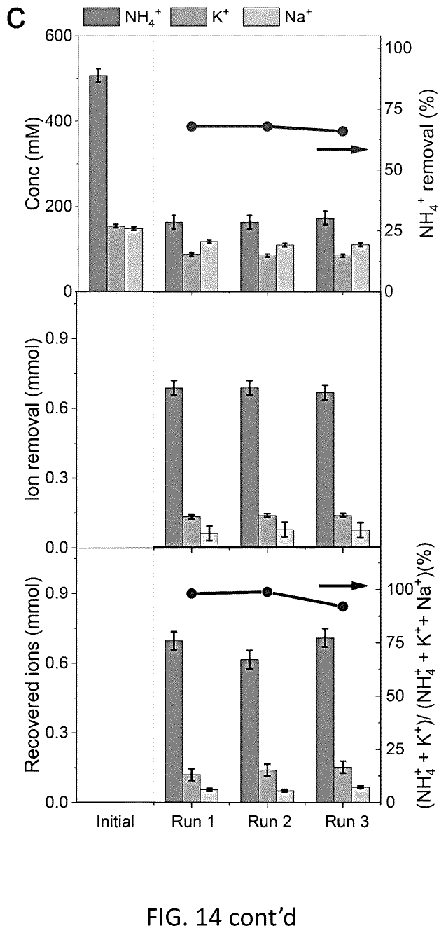

NH₄⁺ recovery was studied from a simpler synthetic wastewater solution (sww, 0.50 M NH₄⁺, 0.183 M K⁺, and 0.146 M Na⁺) using an integrated electrochemical system that includes an anodic cell for NH₄⁺ uptake from 25 mL synthetic wastewater (Cell_{anodic}), a cathodic cell for NH₄⁺ release in 25 mL 0.1 M Li₂SO₄ solution with a pH of ˜1.3 (Cell_{cathodic}), and a KNiHCF RR electrode with a specific capacity (charge) of 186 C g⁻¹ (FIG. 14a). Here, the anodic or cathodic cell is named based on electrocatalytic half-reactions, not the oxidation/reduction of the redox material. In Cell_{anodic}, the reduction of RR from RR^{OX} to RR^{red} accompanied with the NH₄⁺ uptake was paired with OER at the Pt anode that exhibited an average potential of ˜1.58 V versus SHE (FIG. 14b, red region). In Cell_{cathodic}, the oxidation of RR from RR^{red} to RR^{OX} released NH₄⁺ to complete one recovery cycle, which was paired with HER at the Pt cathode on ˜−0.35 V versus SHE (FIG. 14b, blue region). The ion selectivity and the Faradaic efficiency (FE) of cations (NH₄⁺, K⁺, and Na⁺) were calculated based on the concentrations of cations that were analyzed by ion chromatography (Methods).

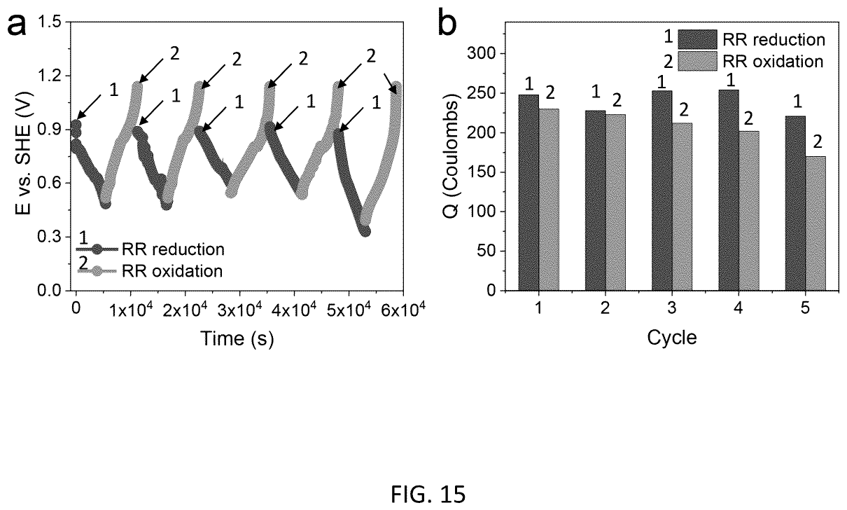

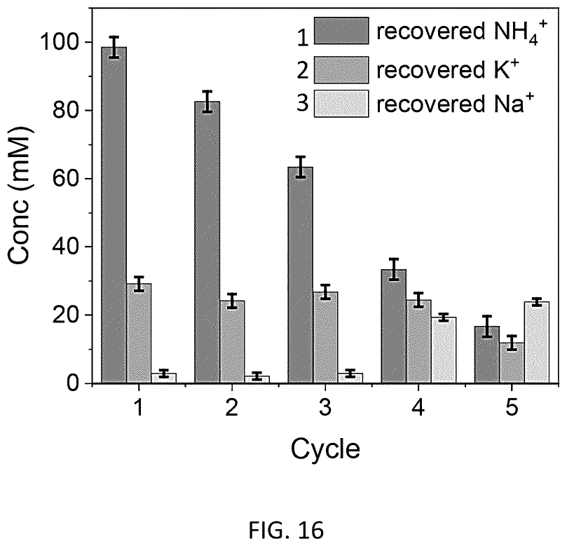

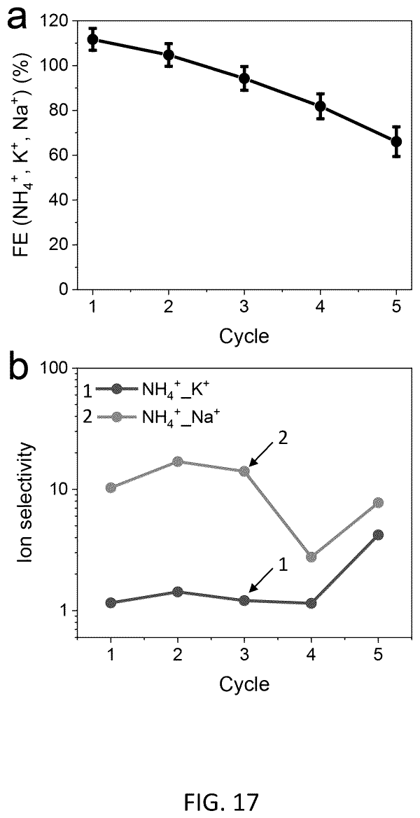

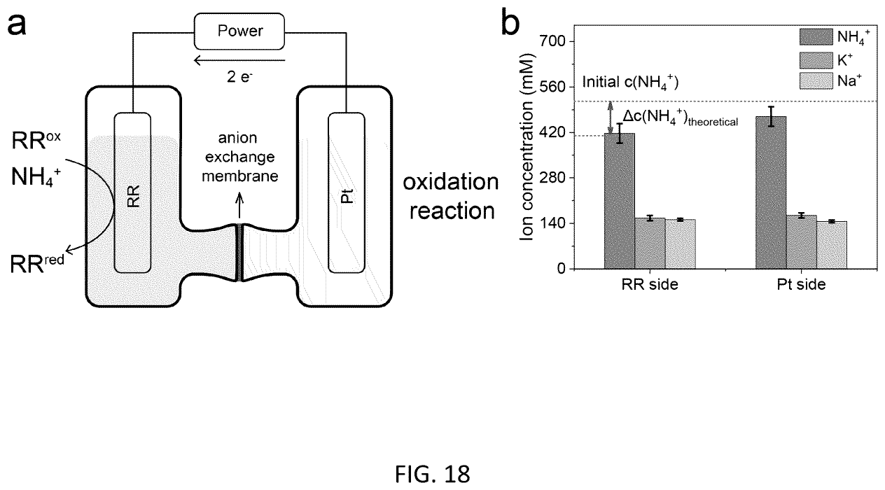

To investigate the relationship between nutrient selectivity and NH₄⁺ removal, five cycles of the recovery process were conducted, where the full recovery process cycle (FIG. 14a) was applied to the same batch of synthetic wastewater five times and the recovered ions were released in a new 0.1 M Li₂SO₄ solution for each cycle (Methods, FIGS. 15 and 16). During the first three cycles, the NH₄⁺ removal increased nearly linearly from 0 to 81% and the Na⁺ concentration ([Na⁺]) in synthetic wastewater showed no apparent changes (FIG. 14c, top panel). The nutrient selectivity in recovered solutions was ˜97% (FIG. 14c, bottom panel), indicating that the KNiHCF electrode preferred the intercalation of NH₄⁺ and K⁺ over Na⁺. During cycles 4 and 5, the NH₄⁺ removal approached ˜100%, but the nutrient selectivity decreased to 54% because limited concentrations of nutrient ions ([NH₄⁺] and [K⁺]) remained in synthetic wastewater (FIG. 14c, top panel). Over five cycles, the FE of cations (NH₄⁺, K⁺, and Na⁺) decreased from 111±5% to 66±6% (FIG. 17a), which might result from the competing proton intercalation due to decreasing pH from OER. The NH₄⁺/Na⁺ selectivity of 6˜14 and NH₄⁺ /K⁺ selectivity of 1.4 (FIG. 17b) confirmed the thermodynamically favorable NH₄⁺ recovery. Comparing the ion removal with ion recovery over five cycles, both K⁺ and Na⁺ were nearly balanced. The KNiHCF electrode recovered 64% of NH₄⁺ ions originally in synthetic wastewater, 18% of NH₄⁺ ions were transfer loss because of the inevitable residual solution on the electrode during electrode transfer, and NH₄⁺ loss was 18%. This NH₄⁺ loss could be due the electrochemical oxidation of NH₄⁺ at the anode or the possible redox reactions between active chlorine (AC) and NH₄⁺ during the NH₄⁺ uptake process (FIG. 18). Since the paired electrochemical oxidation reactions usually require high applied potentials, developing an alternative oxidation process to pair with the reduction of RR will help to maintain the NH₄⁺ balance and achieve a more efficient recovery.

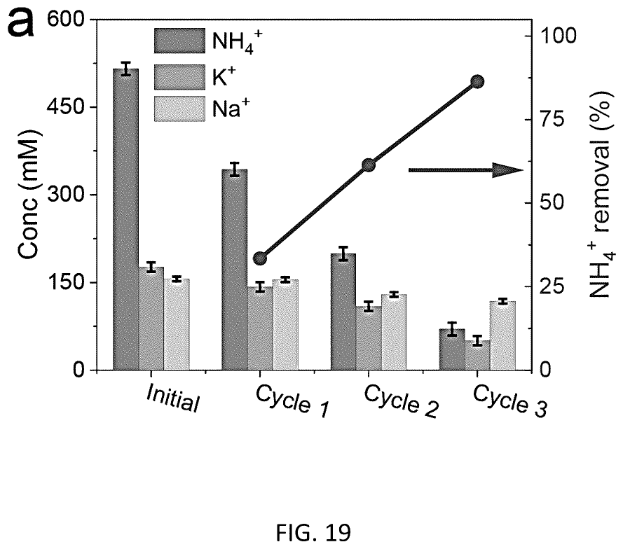

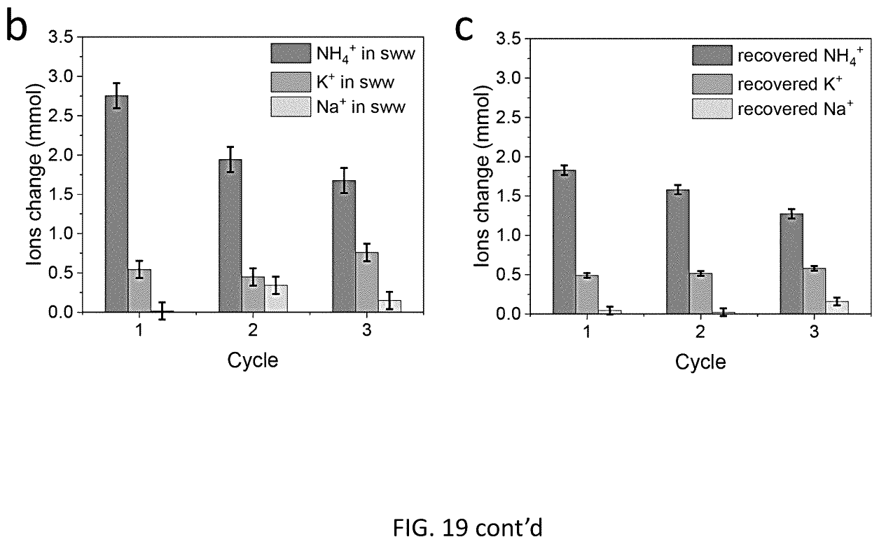

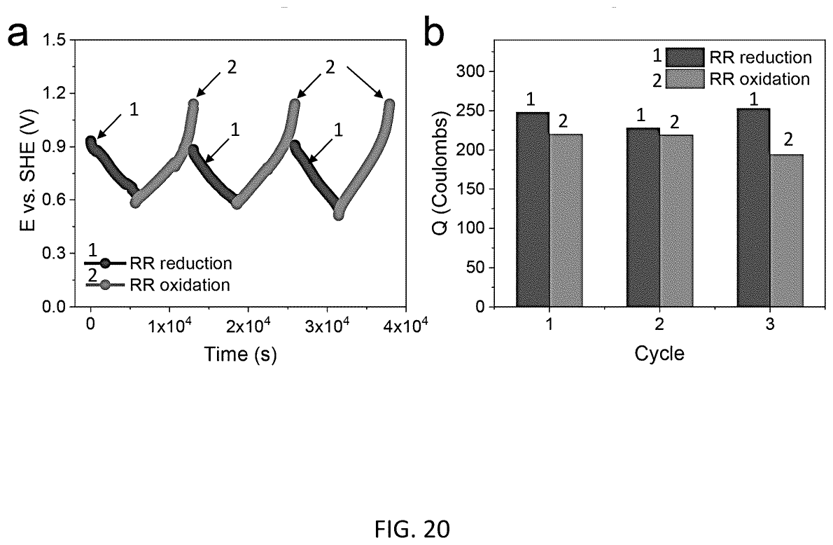

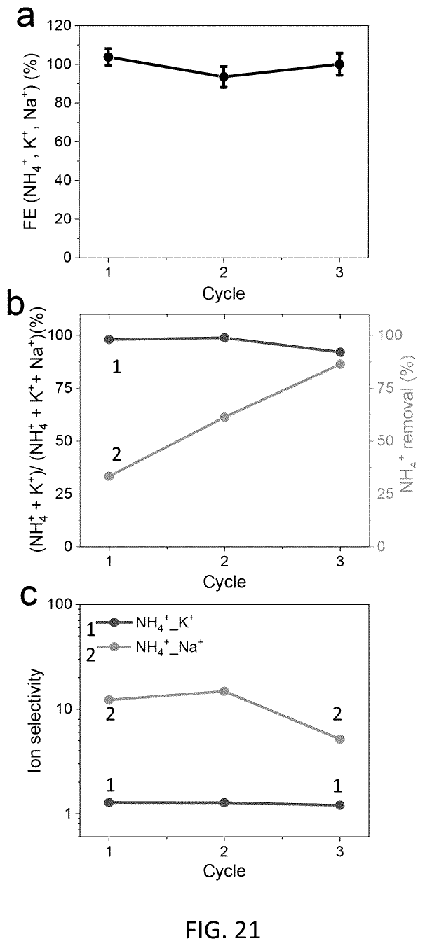

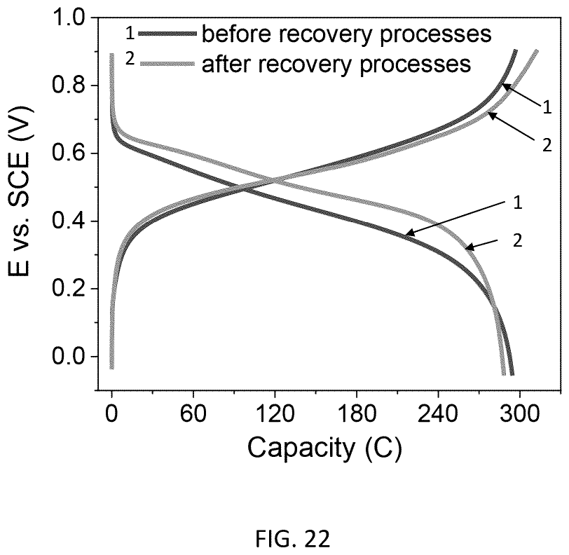

A three-cycle recovery process was performed in synthetic wastewater to further confirm the ion selectivity. Experiment demonstrates ˜10% NH₄⁺ loss and no loss of Na⁺ and K⁺ through the process (FIGS. 19 and 20). Furthermore, the NH₄⁺ removal was ˜90%, with a nutrient selectivity of ˜95% (FIG. 21), confirming a high nutrient selectivity when the NH₄⁺ removal was below ˜90%. Also, after the above five-cycle and three-cycle recovery processes in synthetic wastewater, 98% capacity of the KNiHCF electrode was retained (FIG. 22), indicating excellent cycling stability.

NH₄⁺ Recovery From Manure Wastewater

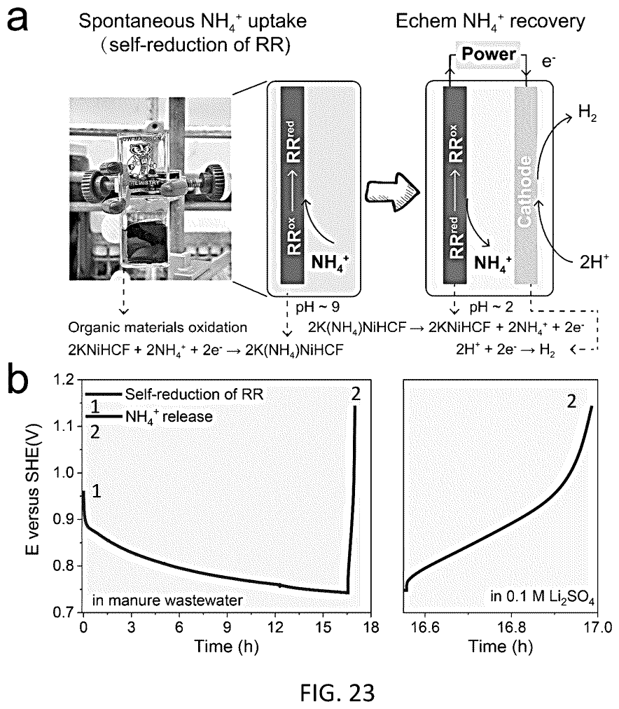

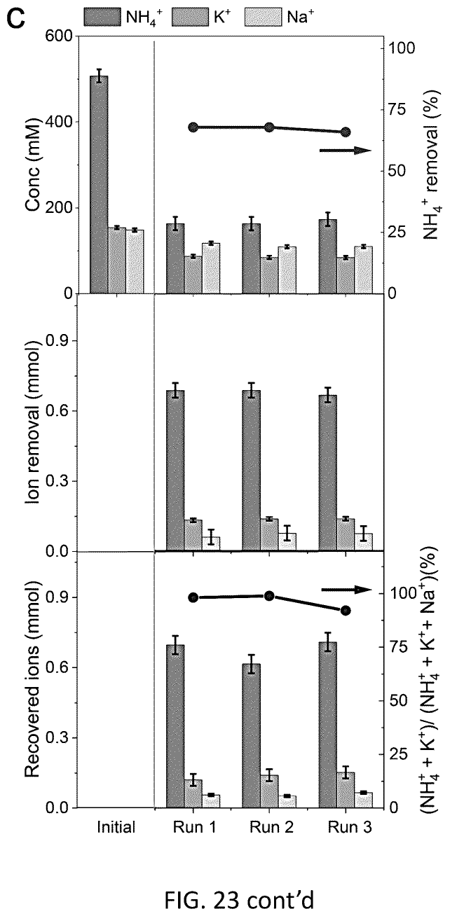

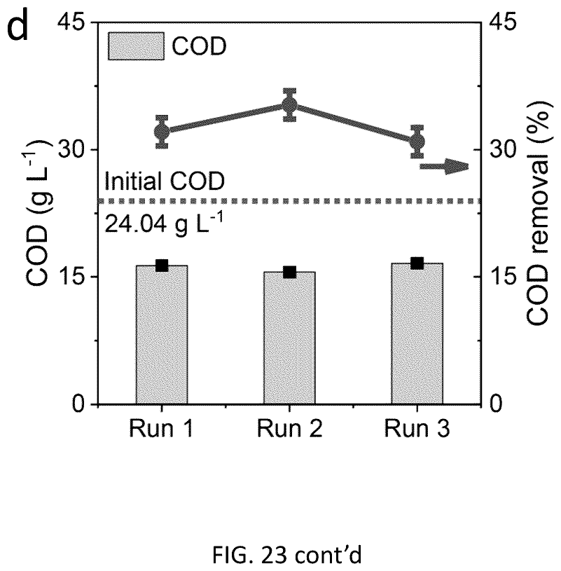

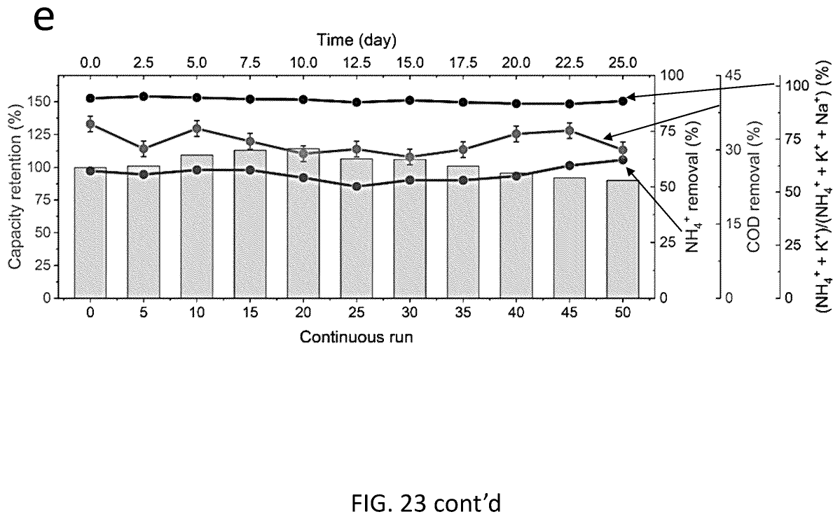

NH₄⁺ recovery from manure wastewater was investigated using a two-step recovery process (FIG. 23a) that includes spontaneous NH₄⁺ uptake from 2 mL manure wastewater and electrochemical NH₄⁺ recovery in 10 mL 0.1 M Li₂SO₄ solution with a pH of ˜2. When NH₄⁺ were intercalated into the RR electrode, the KNiHCF electrode was reduced from RR^{OX} to RR^{red} spontaneously by the oxidation of organic matter in manure wastewater (FIG. 23b, red region). Then NH₄⁺ was released during the RR oxidation, which is paired with HER at the Pt electrode to finish one recovery cycle (FIG. 23b, blue region).

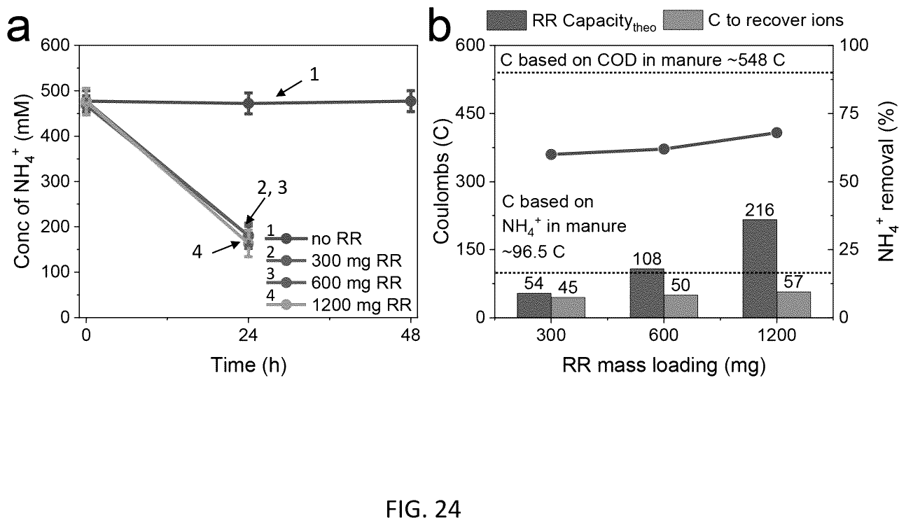

The Experiment studied how NH₄⁺ recovery in manure wastewater was influenced by the capacity of the RR electrode (FIG. 24) and then conducted three parallel recovery processes, noted as run 1, 2, and 3, using a KNiHCF electrode with a capacity twice the minimal charges to recover NH₄⁺ ions from manure wastewater. Each run was one recovery cycle that included spontaneous NH₄⁺ uptake and electrochemical NH₄⁺ recovery processes. For a typical recovery run, the [NH₄⁺], [K⁺], and [Na⁺] in manure wastewater were reduced by ˜344 mM, 69 mM, and 35 mM, respectively

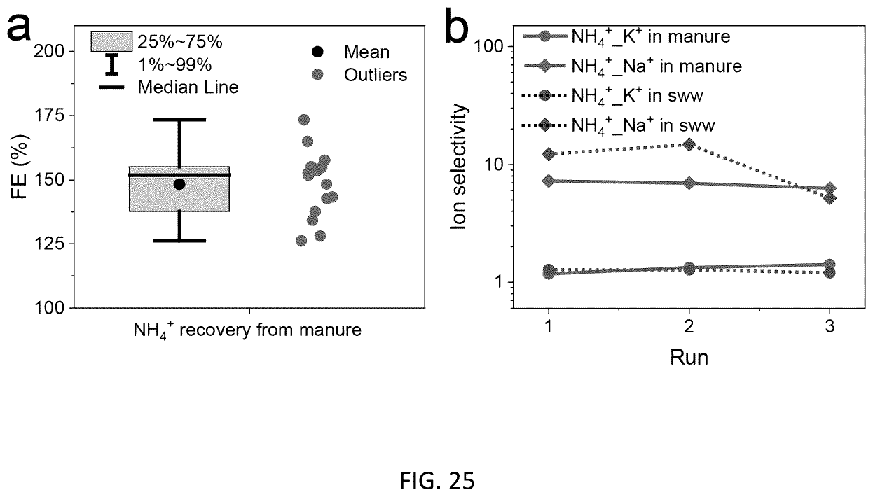

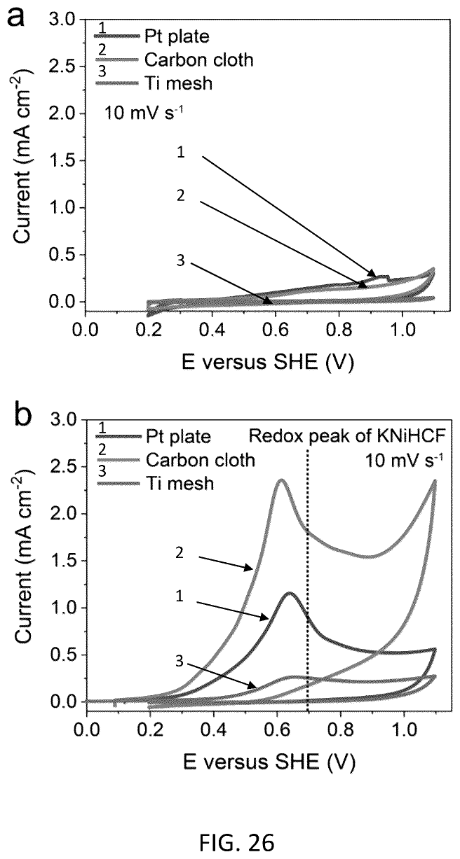

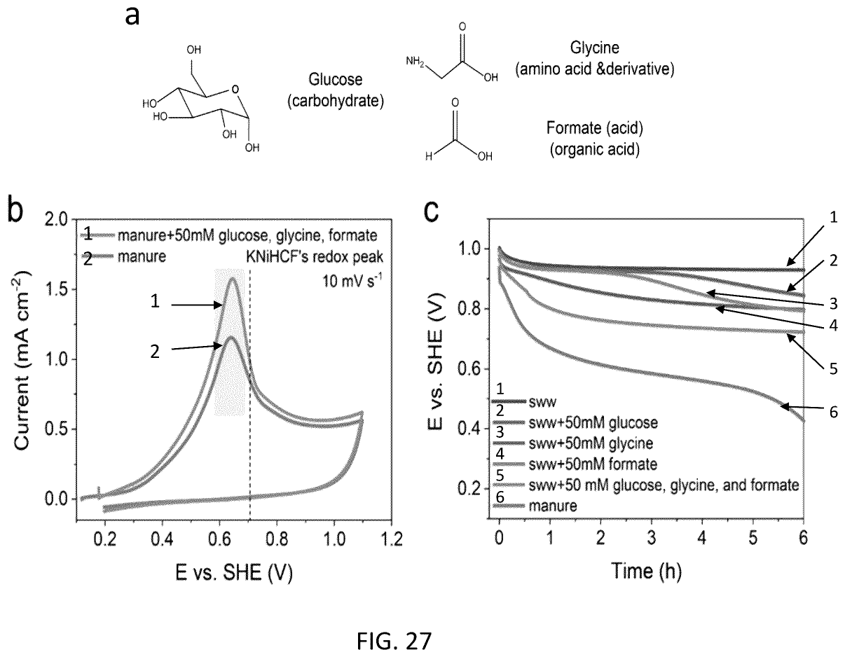

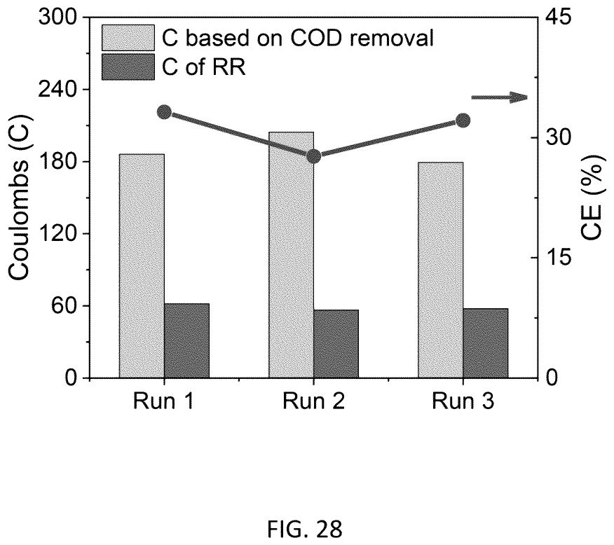

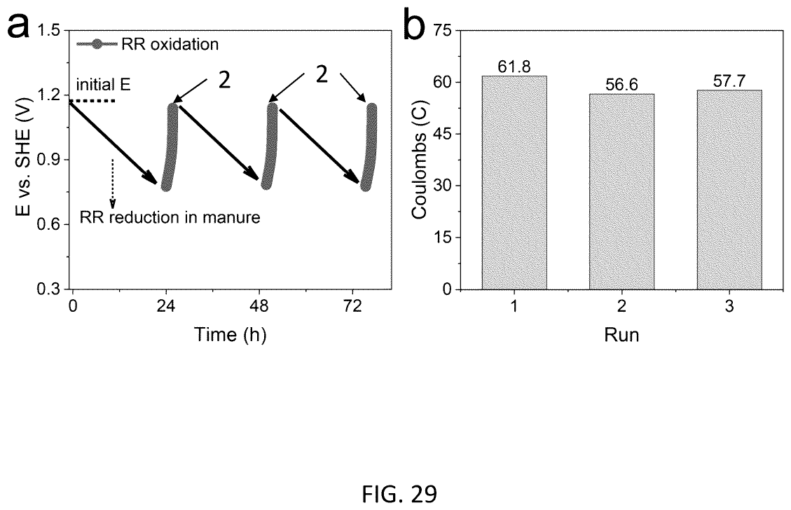

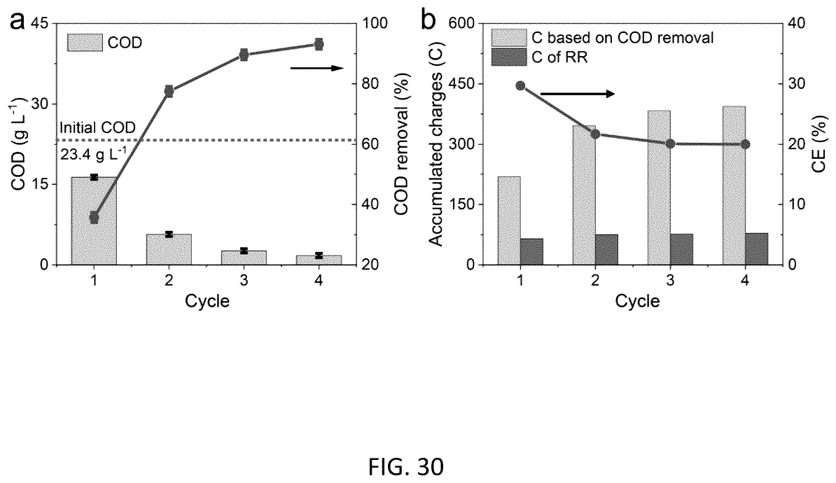

(FIG. 23c, top panel). The NH₄⁺ removal in manure wastewater was 66˜68% for each run (FIG. 23c, top panel). The nutrient selectivity was 93˜98% in the recovered solutions (FIG. 23c, bottom panel). The NH₄⁺/Na⁺ selectivity of 6˜7 and NH₄⁺/K⁺ selectivity of ˜1.3 (FIG. 25) were similar to those achieved in synthetic wastewater. Notably, NH₄⁺, K⁺, and Na⁺ were all nearly balanced between ion removal and ion recovery. On average, ˜68 ±4% NH₄⁺ was recovered in the recovery process, and ˜32 ±3% NH₄⁺ was left in manure wastewater after this one cycle, where the latter could be used as the feedstock for the next-cycle recovery process. Unlike the case of NH₄⁺ recovery in synthetic wastewater, there was nearly zero NH₄⁺ loss in manure wastewater because the electrochemical oxidation process was replaced with the spontaneous oxidation of organic matter. Chemical oxygen demand (COD), the amount of oxygen needed to oxidize the organic matter to carbon dioxide, was measured to quantify the amount of organic matter in manure wastewater. The COD decreased from 24.04±0.4 g L⁻¹ to 15.5˜16.6±0.4 g L⁻¹ (a COD removal of 31%˜35%) during each ammonia recovery run using the RR electrode (FIG. 23d), confirming the spontaneous oxidation of organic matter in manure wastewater by the RR. Cyclic voltammograms of different electrodes in synthetic and manure wastewater (FIGS. 26 and 27) and the self-reduction behaviors of the KNiHCF electrode in synthetic wastewater with model organic molecules (FIG. 27c) show that the oxidized KNiHCF electrode with a high potential enables the oxidation of organic matter driven by their potential difference. Moreover, the Coulombic efficiency, defined as the ratio of the charges passing through the RR (C_{RR}) to the charges needed for COD removal (C_{COD}), is used to evaluate the efficiency of organic-to-electricity over the recovery processes (Example 3). The CE of ˜30% for each run (FIGS. 28 and 29) might result from the complicated bio-related processes in manure wastewater. Also, considering that more organic matter is available for oxidation than the ammonium ions available to recover in manure wastewater (FIG. 24 and Example 2), we could further achieve ˜93% COD removal using the KNiHCF electrode in a 4-cycle NH₄⁺ uptake from the same manure wastewater by adding (NH₄⁺)₂SO₄ salt to maintain the cation concentration (FIG. 30).

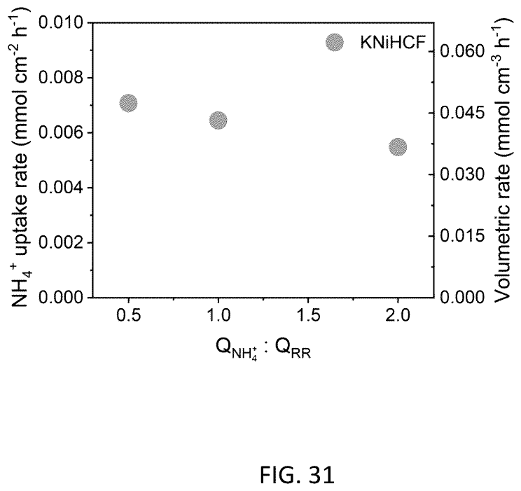

Furthermore, we performed the NH₄⁺ uptake and release process for 50 runs (FIG. 23e, complete details in Table 5) to evaluate the robustness of the KNiHCF electrode. Each run included a 10-hour NH₄⁺ uptake in manure wastewater and nearly 2-hour electrochemical NH₄⁺ release. After 50 runs, the KNiHCF electrode retained 90.1% of its original NH₄⁺-uptake capacity retention, corresponding to an average decay rate of 0.198% per cycle. The surface uptake and release rates using the KNiHCF electrode were 0.0071 mmol cm⁻² h⁻¹ and 0.093 mmol cm⁻² h⁻¹ (FIG. 31), comparable to the values reported for membrane-based (bio) electrochemical systems. These results indicate the excellent performance of the KNiHCF electrode in recovering NH₄⁺ from manure wastewater.

Simultaneous NH₄⁺ Recovery and Electrochemical Production of H₂ and H₂O₂

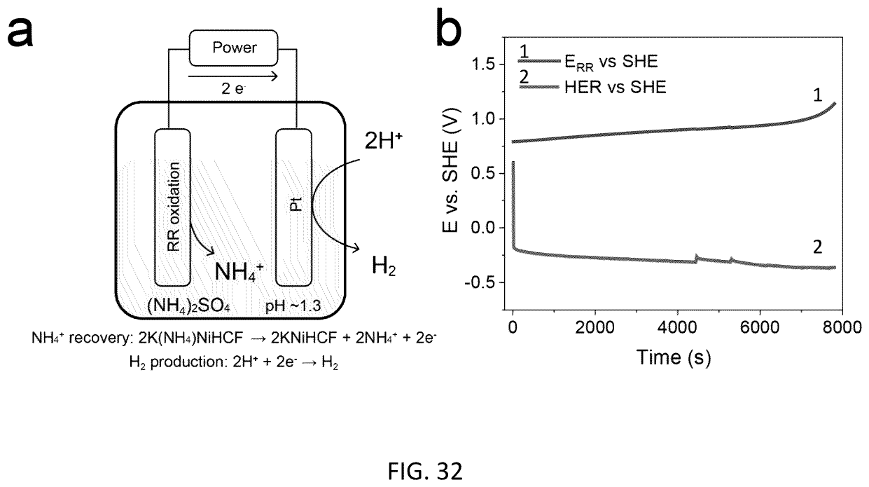

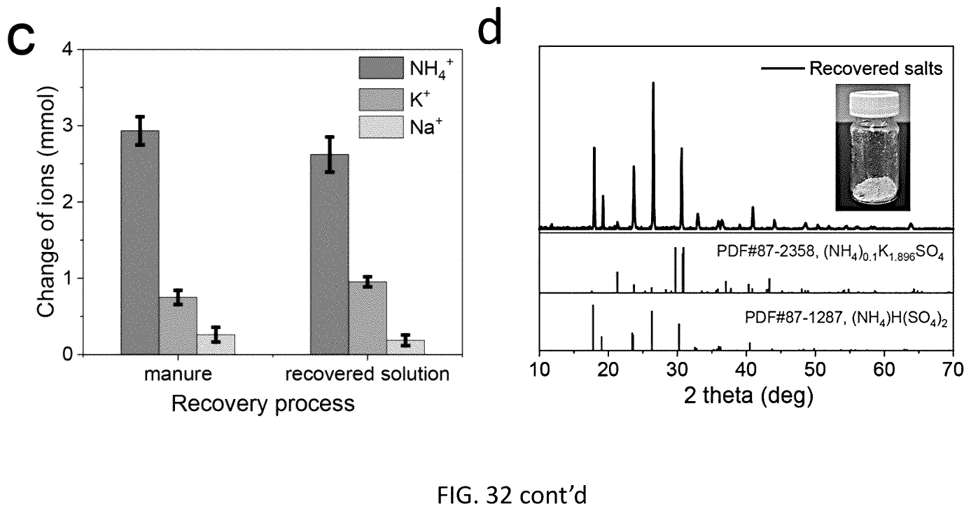

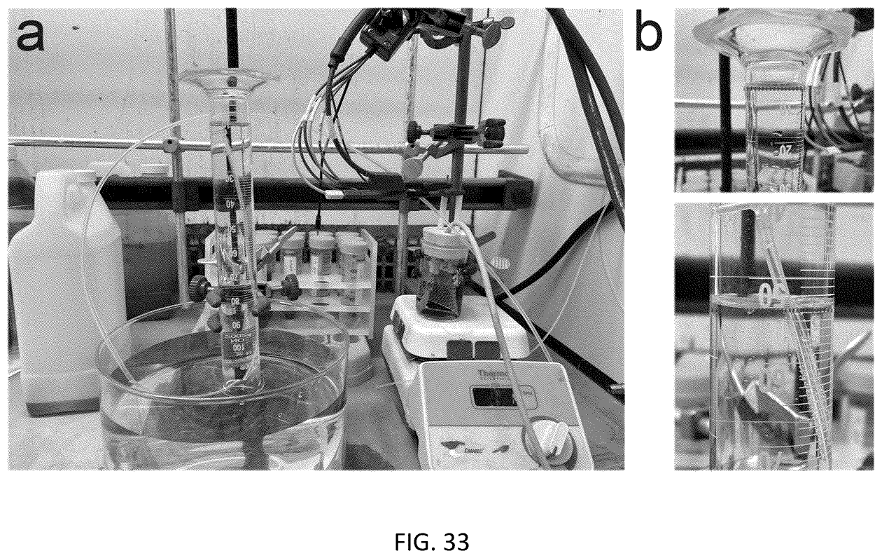

NH₄⁺ recovery and electrochemical H₂ production was demonstrated using similar two-step processes. After the spontaneous NH₄⁺ uptake in 10 mL manure wastewater, the oxidation of the KNiHCF electrode (with a specific capacity of 186 C g⁻¹) that have been intercalated with NH₄⁺ ions released the NH₄⁺ into 25 mL 0.1 M (NH₄⁺)₂SO₄ solution with a pH of ˜1.3. Moreover, this reaction was paired with the production of hydrogen gas on the Pt cathode at −0.30 V versus SHE (FIGS. 32a and b). Over the integrated process of NH₄⁺ recovery and H₂ production with balanced cations (FIG. 32c), we achieved 60% NH₄⁺ removal and 27% COD removal in manure wastewater, and 95% nutrient selectivity in the recovered solution. The FE of H₂ production was 100.7±2.6% based on the volume of the produced H₂ gas (FIG. 33). Moreover, we collected 0.614 g of solid salts by drying the recovered solution, in comparison with the starting mass of the supporting electrolyte (0.331 g (NH₄⁺)₂SO₄). The PXRD pattern of the recovered salt (FIG. 32d) matched with those of (NH₄⁺)₃H(SO₄)₂ (JCPDS No. 87-1287) and (NH₄⁺) 0.1K1.896SO4 (JCPDS No. 87-2358) well, confirming the successful co-production of NH₄⁺-rich fertilizer together with hydrogen gas.

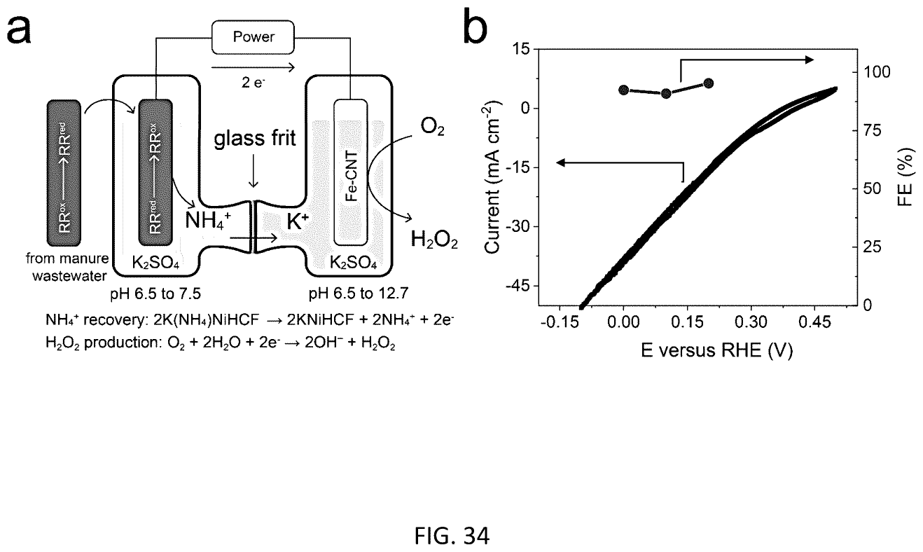

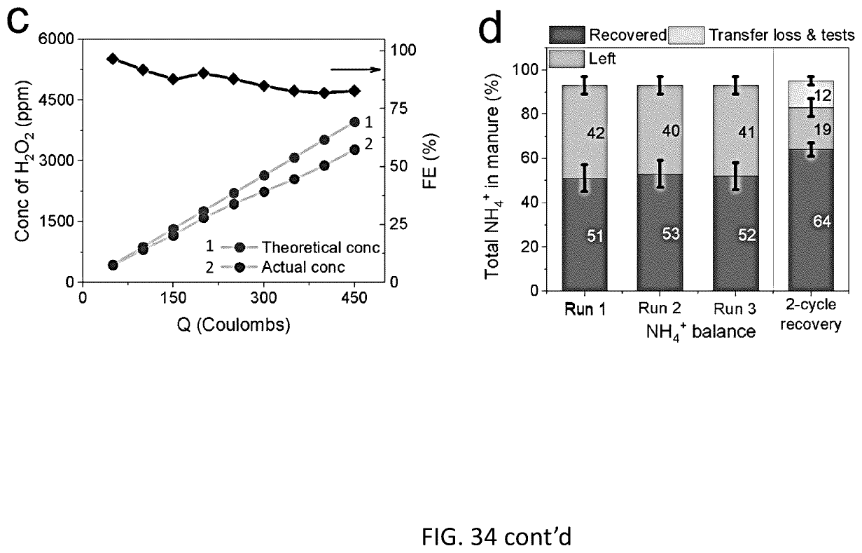

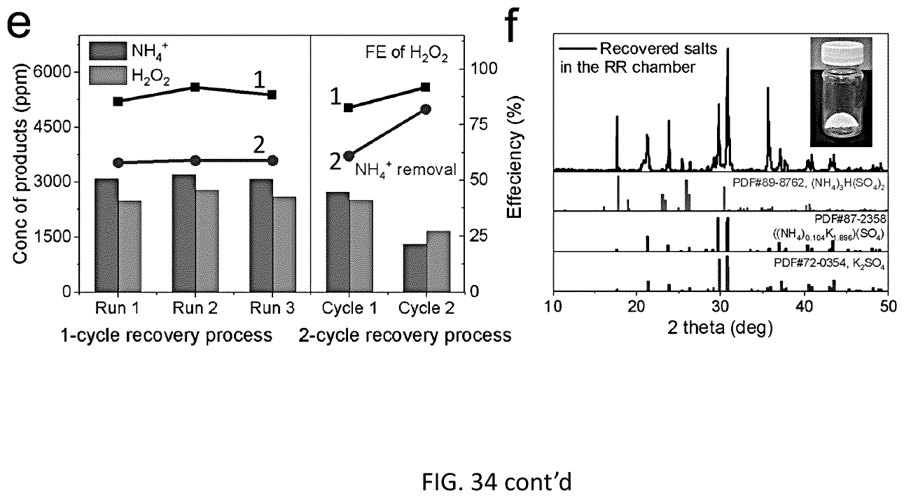

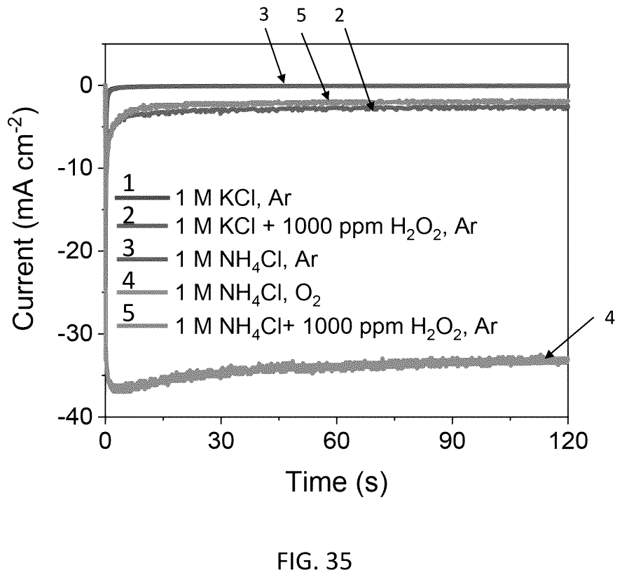

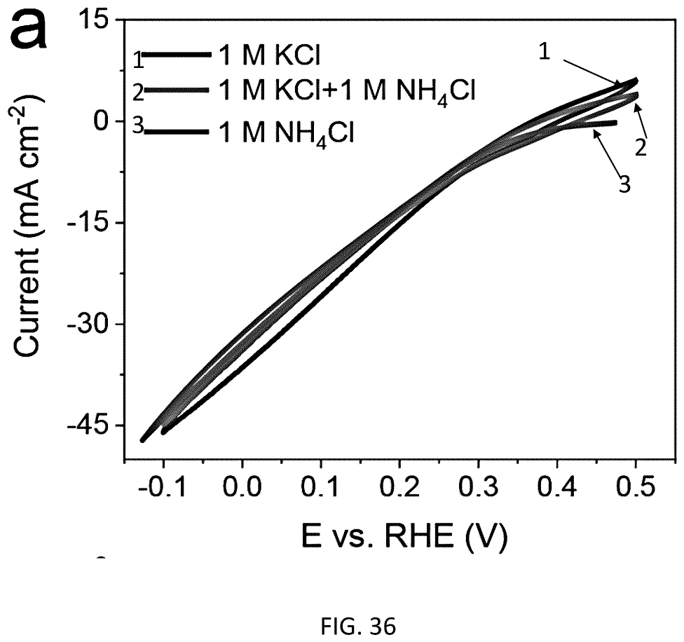

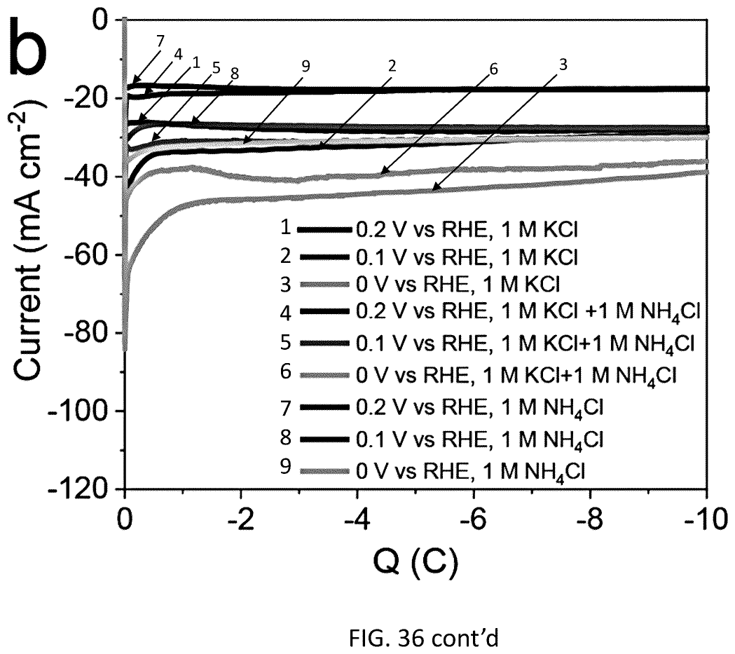

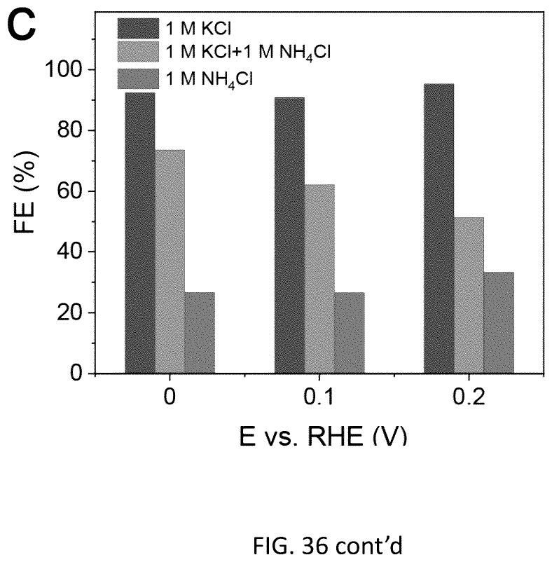

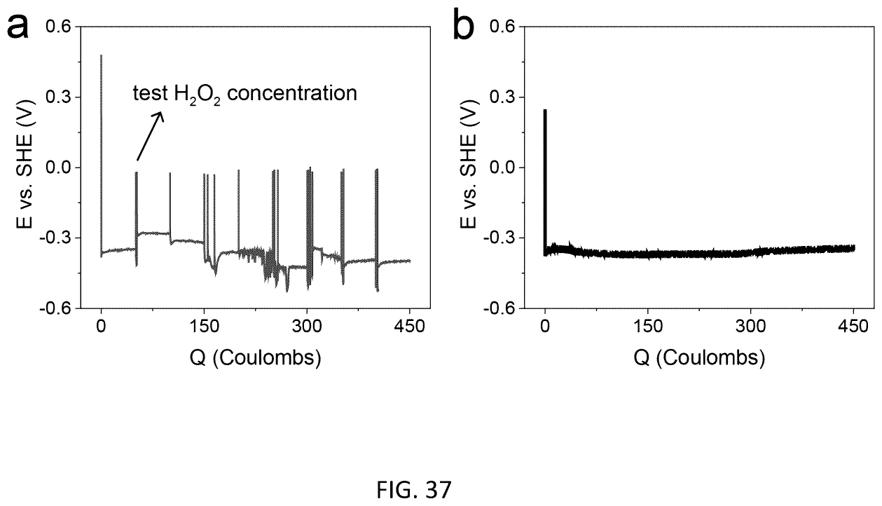

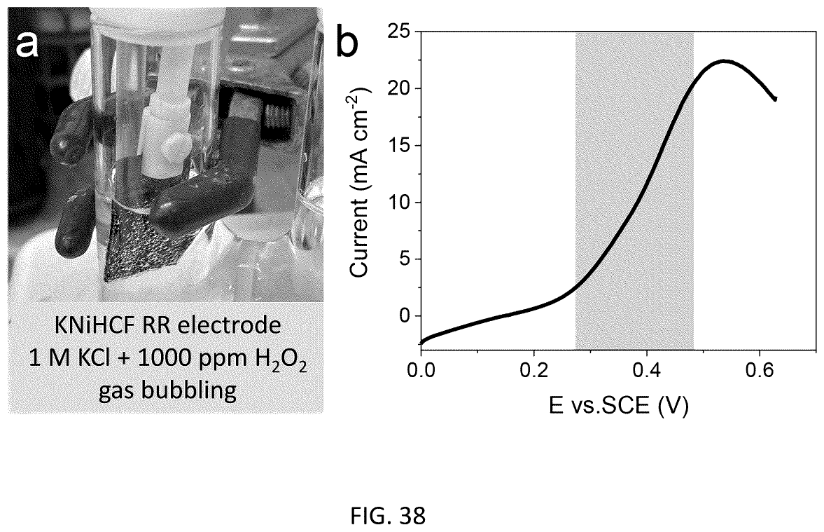

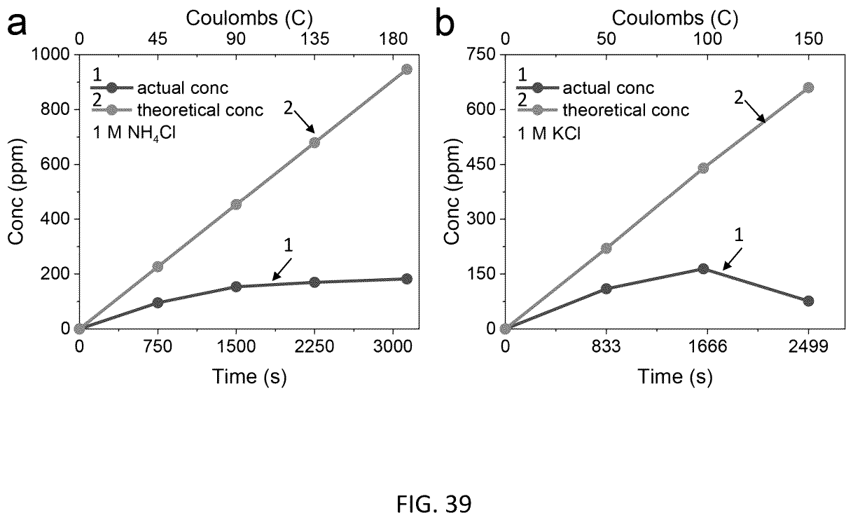

NH₄⁺ recovery could also be paired with the electrochemical two-electron oxygen reduction reaction (2e⁻ORR) to produce H₂O₂ (FIG. 34a), a common oxidant and disinfectant that can be used for wastewater treatment. Fe-decorated carbon nanotube (Fe-CNT) was used as the electrocatalyst for H₂O₂ production because of its good electrochemical activity and stability in neutral and alkaline solutions. Given the high reactivity and intrinsic instability of H₂O₂, we optimized the supporting electrolytes and electrochemical configurations for H₂O₂ production (FIGS. 35-36 and Table 5). Considering that many crops (such as tomatoes and potatoes) are chloride-sensitive, K₂SO₄ (sulfate of potash) was used as the supporting electrolyte. The Fe-CNT electrode in the O₂-saturated 0.5 M K₂SO₄ solution delivered a high current density of 49 mA cm⁻² (98 A g⁻¹) at −0.10 V versus reversible hydrogen electrode (RHE), with the FE above 90% in the potential range of 0.00 to 0.20 V versus RHE (FIG. 34b). With such optimizations, we achieved the accumulation of H₂O₂ up to 3.3 g L⁻¹ with a FE of 82% (FIG. 34c and FIG. 37). In addition, because KNiHCF could decompose H₂O₂ (FIGS. 38 and 39), a divided electrochemical cell may be used to co-produce H₂O₂ and fertilizer.

TABLE 5
Chemical stability of H₂O₂ mixed with NH₄⁺ ions.

| Solution | pH | H₂O₂ (ppm) ^{[a]} |
|---|---|---|
| H₂O | ~7 | 1249 |
| 60 mM NH₄Cl | ~7 | 1250 |
| 1M NH₄Cl | ~7 | 1245 |
| 60 mM NH₄Cl + 60 mM KCl | ~9.2 | 1248 |

[a] 0.5 mL 3 wt % H₂O₂ solution was added to different solutions (nanopure water, 60 mM NH₄Cl, 1 M NH₄Cl, and 60 mM NH₄Cl+60 mM KCl) with a volume of 15 mL. The concentration of H₂O₂ was analyzed using the UV-Vis method after mixing for 2 hours.

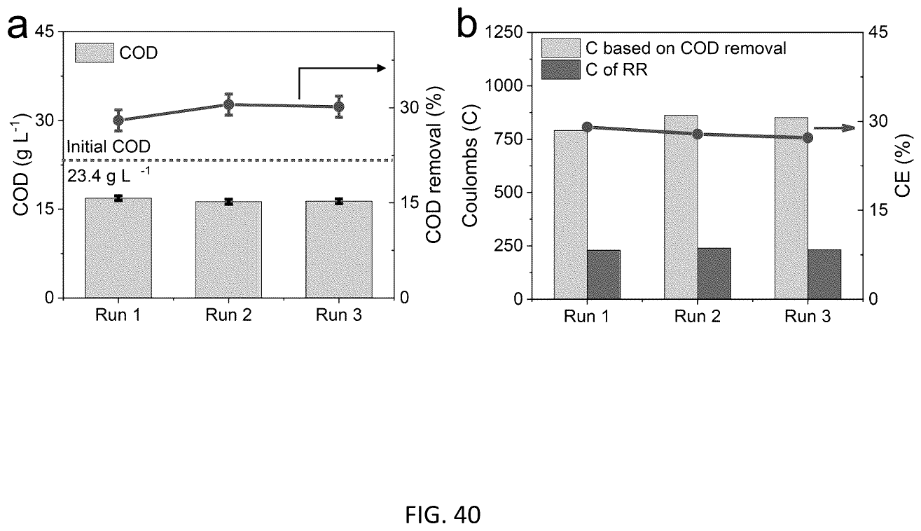

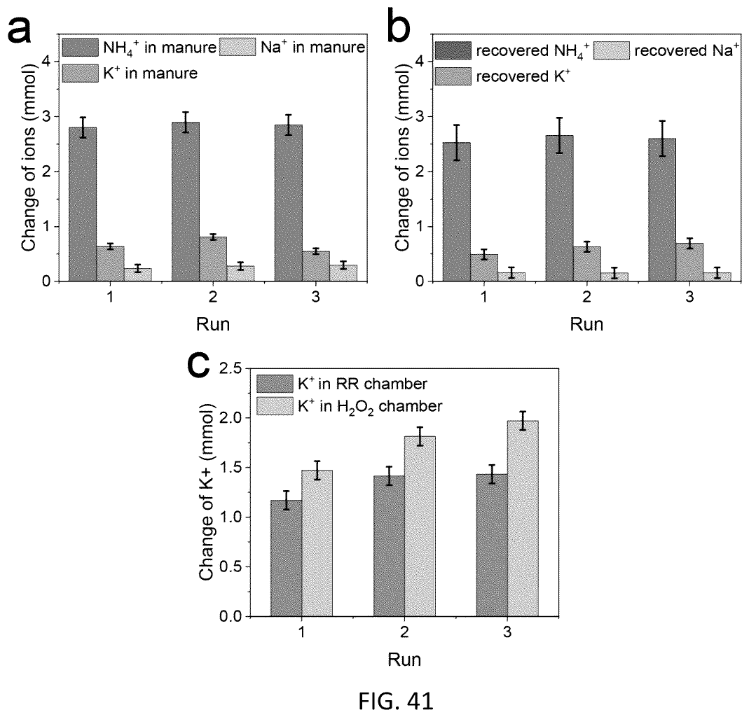

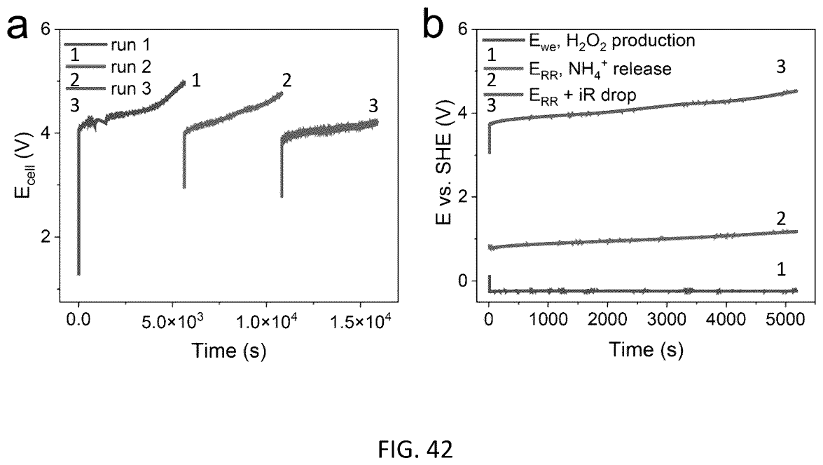

NH₄⁺ recovery and electrochemical H₂O₂ production was demonstrated in a two-compartment H-cell separated by a microporous glass frit (FIG. 34a) that could allow the transport of major ions (e.g., K⁺ and SO₄²⁻ in K₂SO₄ solution) to maintain the charge balance. After the spontaneous NH₄⁺ uptake from 10 mL manure wastewater, three parallel one-cycle processes of NH₄⁺ recovery and H₂O₂ production using a KNiHCF electrode with a capacity of 892 C were conducted, as Run 1, 2, and 3. Over the three runs, COD removal was between 28% to 30% (FIG. 40a), and the corresponding CE (C_{RR}/C_{COD}) was about ˜30%, consistent with the results above (FIG. 40b). After this one-cycle recovery process, 52±6% NH₄⁺ were recovered from and 41±4% NH₄⁺ were left in manure wastewater (FIG. 34d) with a total NH₄⁺ balance of 93±10%. No NH₄⁺ and Na⁺ were detected in the H₂O₂ chamber throughout the recovery processes, but [K⁺] increased in the H₂O₂ chamber and decreased in the RR chamber (FIG. 41), indicating that K⁺ was the major cation crossing the glass frit. These runs produced H₂O₂ up to 2772 ppm with a FE of 91% and released NH₄⁺ up to 3187 ppm (177 mM) with a NH₄⁺ removal of 59% (FIG. 34e and FIG. 42). Charges of 240 C, 232 C, and 232 C passed through the RR electrode over the 3-run recovery and production process. In addition, the PXRD pattern of the salts recovered from the electrolyte in the RR chamber (FIG. 34f) matched with those of (NH₄⁺)₃H(SO₄)₂, (NH₄⁺)_{0.1}K_{1.896}SO₄, and K₂SO₄ (JCPDS No. 72-0354) well, confirming the production of K⁺ and NH₄⁺ fertilizers.

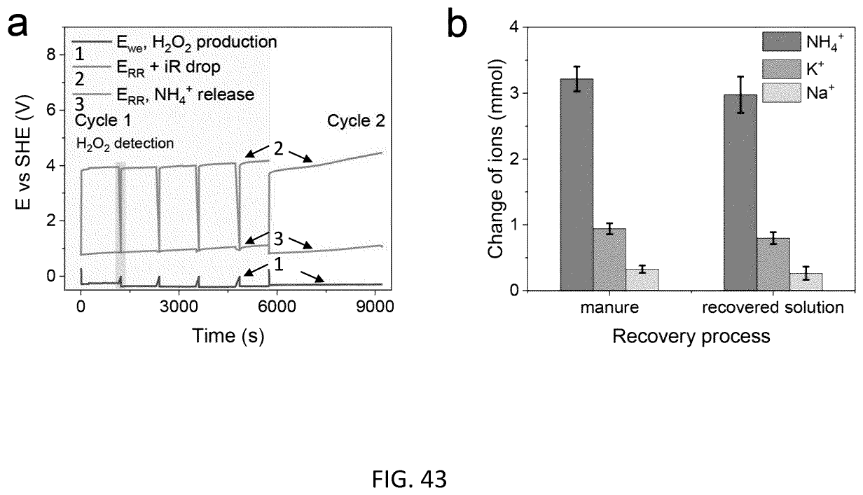

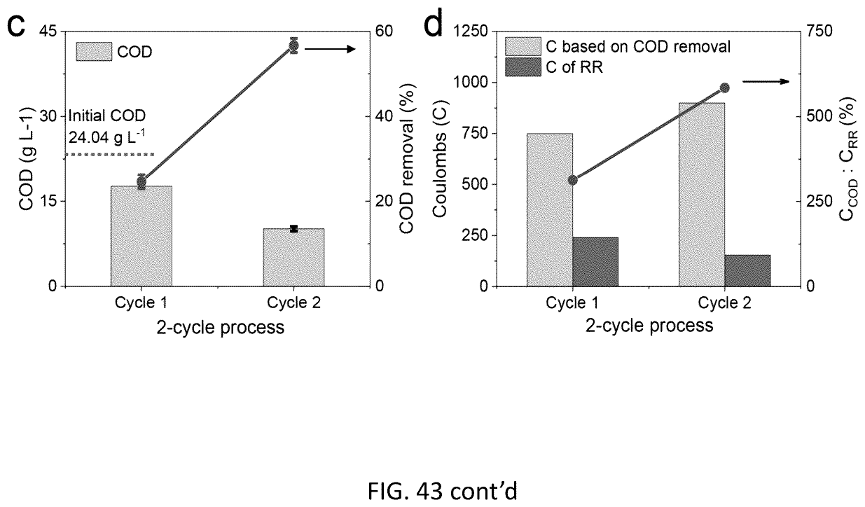

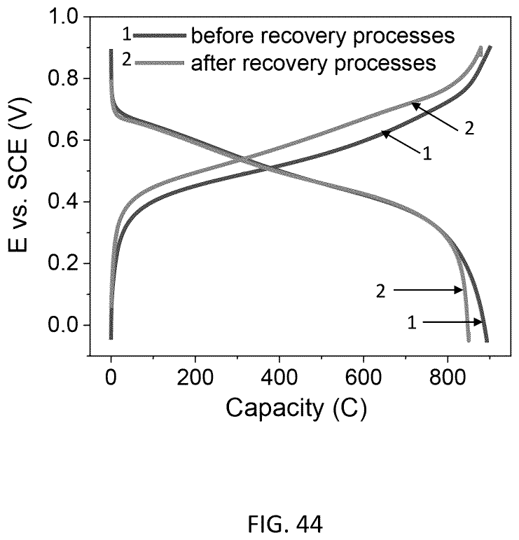

To further improve NH₄⁺ recovery from manure wastewater, we conducted two cycles of NH₄⁺ recovery and H₂O₂ production to achieve a more complete NH₄⁺ removal of 84% and COD removal of 56% (FIG. 34e and FIG. 43). The two-cycle process showed high FE for H₂O₂ production (FIG. 34e), consistent with the above one-cycle process. The KNiHCF electrode retained 96% of the capacity after the above recovery processes (FIG. 42), showing good stability in these complex solutions. Furthermore, we can use the H₂O₂ solution co-produced during the NH₄⁺ recovery processes to disinfect the manure wastewater and then recycle K⁺-rich salts from such treated wastewater, which can be used as electrolytes or fertilizers.

This integrated system for ammonia and/or potassium recovery and chemical production could produce fertilizers at a lower energy consumption and cost. Because the chemical feedstocks mainly come from the manure wastewater or can be recycled in this integrated process, the most significant operational cost for this process include electricity, electrolytes, and ion-selective redox materials. Furthermore, the co-produced H₂O₂ has substantial commercial value and can be useful locally for disinfection and other environmental applications.

### Conclusions

In summary, an electrochemical process for ammonia and nutrient recovery and electrochemical synthesis was developed by integrating spontaneous NH₄⁺ and/or K⁺ uptake from manure wastewater, fertilizer production, and electrochemical production of H₂ or H₂O₂, using an ion-selective redox material. The developed electrode with a high NH₄⁺ and/or K⁺ selectivity, a suitable redox potential, and good chemical and electrochemical stability enables the spontaneous ion-selective intercalation into the open framework redox material driven by the oxidation of organic matter in manure wastewater. Model NH₄⁺ recovery processes in synthetic wastewater reveal near 100% nutrient selectivity of the ammonium-ion selective redox material. In addition, recovery processes from manure wastewater exhibit spontaneous uptake of NH₄⁺ and K⁻ ions with excellent ion selectivity and little NH₄⁺ loss, as well as the reduction of organic matter content. Furthermore, the developed electrochemical system achieves the co-production of NH₄⁺ and K⁺-rich fertilizer and hydrogen gas as a green fuel or H₂O₂ as a disinfectant for wastewater treatment and could allow the recycling of K⁺-rich salts as electrolytes or fertilizers. The disclosed technology provides for electrochemical nutrient recovery from wastewater and on-demand distributed electrochemical manufacturing with high recovery efficiency and low energy cost.

### Methods

### Chemicals.

All chemicals were used as purchased without further purification. Sodium citrate dihydrate (ACS reagent grade) was purchased from ICN Biomedicals Inc. Carbon black (Super P Conductive, 99.0+%) and carbon black (acetylene, 99.9+%) were purchased from Alfa Aesar.

TUBALL BATT NMP 0.4% (a mixture of single-wall carbon nanotubes, 0.4 wt %; polyvinylidene fluoride, 2 wt %; N-methyl-2-pyrrolidone, >96.7 wt %) was purchased from OCSiAl. Other chemicals were purchased from Sigma Aldrich. Titanium mesh (150 mesh, with a thickness of ˜230 um) was purchased from HeBei ChaoChuang Metal Mesh Co., Ltd., available through Alibaba.com. Deionized nanopure water (18.2 MΩ·cm) from ThermoScientific Barnstead water purification systems was used for all experiments.

### Synthesis of KNiHCF.

Potassium nickel hexacyanoferrate (KNiHCF) was synthesized using a modified co-precipitation method (Wessells CD, Peddada SV, Huggins RA, Cui Y. Nickel Hexacyanoferrate Nanoparticle Electrodes For Aqueous Sodium and Potassium Ion Batteries. Nano Lett 11, 5421-5425, 2011). Typically, 80 mL of 40 mM Ni(NO₃)₂ solution and 80 mL of 20 mM K₃Fe(CN)₆ solution were added dropwise into 40 mL H₂O under vigorous stirring. The solution was stirred for 6 h at 70° C. to yield a dark-orange precipitate. Then the precipitate was centrifuged, rinsed with deionized water multiple times, and dried in a vacuum oven at 60° C. overnight. ps Synthesis of NaNiHCF.

Sodium nickel hexacyanoferrate (NaNiHCF) was synthesized using a co-precipitation method (Wang F, et al. Modular Electrochemical Synthesis Using a Redox Reservoir Paired with Independent Half-Reactions. Joule 5, 149-165, 2021). Typically, 100 mL of 0.1 M NiCl₂ and 1 M sodium citrate dihydrate solution and 100 mL of 0.1 M Na⁺Fe(CN)₆ solution were added dropwise to 100 mL H₂O under vigorous stirring. The molar ratio between Ni²⁺ and citrate was 1:10. The solution was then stirred for 24 h at 80° C. to yield a light-green precipitate. This precipitate was centrifuged, rinsed with deionized water multiple times, and dried in a vacuum oven at 60° C. overnight.

### Synthesis of CuHCF.

Copper hexacyanoferrate (CuHCF) was synthesized using a modified co-precipitation method (Wu X, et al. Diffusion-free Grotthuss topochemistry for high-rate and long-life proton batteries. Nat Energy 4, 123-130, 2019). Typically, 40 mL of 0.2 M CuSO₄ solution was added dropwise into 40 mL of 0.1 M K₃Fe(CN)₆ solution under vigorous stirring at room temperature. After 6 h of reaction, the olive-green precipitate was centrifuged, rinsed with deionized water multiple times, and dried in a vacuum oven at 60° C. overnight.

### Synthesis of Fe-CNT Catalyst.

The synthesis of Fe-CNT catalyst followed a reported impregnation and reduction method (Wang R, Sheng H, Wang F, Li W, Roberts DS, Jin S. Sustainable Coproduction of Two Disinfectants via Hydroxide-Balanced Modular Electrochemical Synthesis Using a Redox Reservoir. ACS Cent Sci 7, 2083-2091, 2021). In a typical synthesis, a 7.5 mM iron nitrate solution was first prepared by dissolving 30.3 mg Fe(NO₃)_{3.9}H₂O into 10 mL nanopure water. Next, the carbon nanotube (CNT) suspension was prepared by mixing 50 mg MWCNT (724769, >95% carbon from Sigma Aldrich) with 20 mL of ethanol via sonication for 1 h until a well-dispersed suspension was achieved. Then 200 μL of 7.5 mM Fe⁻³ solution was added dropwise into the CNT suspension under sonication for 30 min. Then the solvent was removed using a rotary evaporator, and the as-prepared material was dried in a vacuum oven at 60° C. for 20 min to evaporate the residual solvent further. Finally, the dried Fe(NO₃)₃/CNT powder was heated in a tube furnace to 600° C. within 20 min under a gas flow of 100 sccm Ar (UHP, Airgas) and a pressure of 1 Torr and kept at the same temperature for another 40 min before cooling down to room temperature.

### Materials Characterizations.

Powder X-ray diffraction (PXRD) patterns of the KNiHCF, NaNiHCF, and CuHCF samples were collected using a Bruker D8 Advance X-ray diffractometer equipped with Cu-Kα radiation. The size and morphology of the samples were characterized using a scanning electron microscope (SEM, Zeiss SUPRA 55VP) equipped with an energy-dispersive X-ray spectroscopy (EDS) detector. An inductively coupled plasma-optical emission spectrometer (ICP-OES, Agilent 5110) was utilized to determine the compositions of K, Na, Cu, Ni, and Fe elements. Thermogravimetric analysis (TGA, TA Q500) was used to determine the water content in various samples.

### Fabrication and Electrochemical Tests of the RR Electrodes.

The RR electrodes were prepared via a conventional slurry-casting method using TUBALL BATT NMP 0.4% (0.4 wt % SWCNT, 2 wt % polyvinylidene fluoride, >96.7 wt % N-Methyl-2-pyrrolidone), super P conductive carbon, and the active materials. Typically, 70 wt % active materials and 18 wt % Super P carbon black were grounded for 30 min using a high-energy ball mill (Mixer/Mill 8000M, Horiba). Then the mixtures were added into TUBALL BATT NMP 0.4% that provided 2 wt % SWCNT and 10 wt % polyvinylidene fluoride for the electrode slurry (SWCNT and PVDF both from TUBALL BATT NMP 0.4%). The slurry was stirred at 700 r.p.m. overnight at room temperature and then cast onto titanium mesh current collectors (150 mesh, with a thickness of ˜ 230 μm). The titanium mesh was held in place by two PTFE (polytetrafluoroethylene) plates on both sides of the mesh and a clamp to secure the plates. The slurry was cast onto one side of the Ti mesh and subsequently onto the other side using stainless steel spatulas. The prepared electrodes were dried in a vacuum oven at 60° C. for 12 h to remove the residual solvent. The areal mass loading ranged from 5 to 24 mg cm⁻².

The electrochemical performance of the RR electrode was characterized in a three-electrode cell, with a Pt wire counter electrode and a saturated calomel electrode (SCE) as the reference electrode in various solutions (1 M NH₄Cl, 1 M KCl, 1 M NaCl, synthetic wastewater, and manure wastewater). Synthetic wastewater (0.50 M NH₄Cl+0.183 M KHCO₃+0.146 M NaHCO₃) was prepared based on the chemical compositions of manure wastewater (Table 1). Manure wastewater with a pH of ˜7 was prepared by acidifying manure wastewater (pH˜9) using 3 M H₂SO₄. Cyclic voltammetry (CV) and galvanostatic charge-discharge (GCD) tests of the RR electrodes were recorded on a Bio-Logic VMP-3 multichannel potentiostat. The galvanostatic cycling was performed at 2 C rate for stability characterization and the rates of 1 C to 1000 C for the kinetics characterization, where 1 C is defined as 65 mA g⁻¹ based on the theoretical capacity of as-synthesized materials. For studying the self-reduction behaviors, two KNiHCF RR electrodes with similar mass loading (˜80 mg) were oxidized to 0.9 V vs. SCE in synthetic wastewater and transferred to two beaker-type cells containing 80 mL of either manure or synthetic wastewater. The potentials of the RR electrodes were monitored using a Bio-Logic SP-200 potentiostat.

### Preparation of Manure Wastewater.

Cow feces and urine were collected from the campus dairy cattle center at UW-Madison and stored in the cold room at 4° C. before use. To prepare manure wastewater, the feces and urine were mixed with a mass ratio of 1:9 with trace carbon black under stirring (e.g., 20 g feces, 180 g urine, and ˜10 mg carbon black for a typical preparation). Since this solid-liquid mixture could not pass the filter membrane with a pore size smaller than 10 μm even when a vacuum system was used, centrifugation would be the proper method to separate the solids with large particle sizes. Here, trace carbon black was added to the mixture of cow urine and feces to achieve solid-liquid separation because it could work as the coagulation reagent and be easily separated from manure wastewater after centrifugation. After centrifugation at 9000 r.p.m for 15 min at 4° C. (50 g of the mixture in each centrifuge tube), the brownish supernatant with some suspended particles was used as manure wastewater without further filtration throughout this study. The precipitate with a brownish-yellow color was formed gradually during the storage of manure wastewater, but the precipitate was not used in the study.

### Chemical Characterization of Manure Wastewater and Recovered Solutions.

Manure wastewater was used without further treatment, and its pH value was determined to be 9.0-9.2 using the Orion 810 BNUWP ROSS Ultra pH meter. The concentrations of various cations ([NH₄⁺], [K⁺], and [Na⁺]) and anions in the manure wastewater and recovered samples were analyzed using ICS-1100 (cations) and Dionex ICS-2100 (anions) ion chromatography (IC) systems equipped with conductivity detectors, respectively. Typically, cation analysis was performed using a Dionex™ IonPac™ CS12A IC column with 7.5 mM methanesulfonic acid (MSA) solution as the mobile phase at 1.5 mL min⁻¹. The current of the suppressor was 33 mA. Antion analysis was performed using a Dionex™ IonPac™ AG/AS-14 column with 3.5 mM Na₂CO₃ and 1.0 mM NaHCO₃ solution as the mobile phase at 1.2 mL min⁻¹. The current of the suppressor was 24 mA. The standard cation solutions were prepared by dissolving NaCl, LiCl, KCl, and NH₄Cl in nanopure water. The standard anion solutions were prepared by dissolving NaF, NaBr, NaCl, NaNO₂, NaNO₃, NaH₂PO₄, and Na₂SO₄. The standard acetate solution was prepared by dissolving only sodium acetate without other salts in nanopure water because of F⁻and acetate coelution. All samples were diluted and filtrated using 0.45 μm syringe filters before analysis.

Total nitrogen (TN) in manure wastewater was analyzed using the total nitrogen reagent set from Hach (Total Nitrogen Reagent Set, HR, TNT, product #2714100). Total phosphate in manure wastewater was analyzed using the total phosphate reagent set from Hach (High Range Total Phosphate Reagent Set, product #2767245). Total carbon, organic carbon, and inorganic carbon in manure wastewater were analyzed using a Sievers M5310C total organic carbon analyzer after proper dilution and filtration. Chemical oxygen demand (COD) of manure wastewater was analyzed using the COD reagent set from Hach [TNTplus Vial Test, HR (20-1,500 mg/L COD), product #2415925].

NH₄⁺ recovery From Synthetic Wastewater.

Two electrochemical cells, the NH₄⁺-uptake cell (Cell_{anodic}) containing 25 mL synthetic wastewater and the NH₄⁺-release cell (Cell_{cathodic}) with 25 mL 0.1 M Li₂SO₄ solution (PH ˜1.3), were used to recover NH₄⁺ from synthetic wastewater. The KNiHCF RR electrodes with the size of 4×4 cm² and a total capacity of 294 C were prepared as described above and used as the working electrode in both cells. In Cell_{anodic}, a Pt wire electrode and a SCE were used as the counter electrode and reference electrode. In addition, about 1 g CaCO₃ was added to the electrochemical cell to stabilize the pH. The NH₄⁺-uptake process was conducted under a current of 45 mA. In Cell_{cathodic}, a Pt wire electrode and a SCE were used as the counter electrode and reference electrode. The NH₄⁺-release process using KNiHCF RR electrodes was measured under a constant current of 30 mA.

Typically, one NH₄⁺ recovery cycle included the NH₄⁺ uptake from wastewater and the NH₄⁺ release in Li₂SO₄ solution. For the five-cycle recovery process, the cations in the same 25 mL synthetic wastewater were recovered five times, and the recovered ions were collected in a new 0.1 M Li₂SO₄ solution for each cycle. The RR electrodes were oxidized to 0.9 V vs. SCE (RR^{OX}) in synthetic wastewater to de-intercalate cations before the NH₄⁺ recovery processes. In Cell_{anodic}, the reduction of RR^{OX} to RR^{red} is accompanied by cation intercalation, which was paired with OER at the Pt anode. After the NH₄⁺ uptake, the RR electrode was washed with nanopure water and 0.1 M Li₂SO₄ solution to remove the residual electrolyte, then moved to Cell_{cathodic}. In Cell_{cathodic}, the oxidation of RR released intercalated cations until 0.9 V vs. SCE, which was paired with HER at the Pt cathode. During these recovery processes, the capacity of the RR electrode was controlled by the potential and capacity restrictions to ensure the RR electrode was operated within the desired potential windows. For the three-cycle NH₄⁺ recovery process, Cell_{anodic} contained 16 mL synthetic wastewater and Cell_{cathodic} contained 18 mL 0.1 M Li₂SO₄ solution (PH ˜1.3). Other electrochemical configurations and operations were the same as those for the five-cycle recovery process.

The concentrations of cations in synthetic wastewater and recovered solutions after each recovery cycle were measured by IC following the above procedures. Based on the concentrations of cations, the ion selectivity between different cations, nutrient (NH₄⁺ +K⁺) selectivity, and Faradaic efficiency (FE) were calculated according to the following equations:

$$Ion selectivity ( M / N ) = \frac{{[ M ]}_{recovered} {/ [ N ]}_{recovered}}{{[ M ]}_{initial} {/ [ N ]}_{initial}} \qquad ( 1 )$$

$$Nutrient ( {NH}_{4}^{+} + {K}^{+} ) selectivity = \frac{{[ {NH}_{4}^{+} ]}_{recovered} + {[ {K}^{+} ]}_{recovered}}{{[ {NH}_{4}^{+} ]}_{recovered} + {[ {K}^{+} ]}_{recovered} + {[ {Na}^{+} ]}_{recovered}} \qquad ( 2 )$$

$$FE ( \% ) = \frac{Q based on recovered cations}{{Q}_{RR}} \times 100 \qquad ( 3 )$$

where the [M]_{recovered} and [N] _{recovered} were the concentrations of M and N cations in the recovered solutions, the [M]ᵢₙᵢₜᵢₐₗ and [N]ᵢₙᵢₜᵢₐₗ were the concentrations of M and N cations in synthetic wastewater, [NH₄⁺]_{recovered} +[K⁺]_{recovered} +_{recovered} [Na⁺]_{recovered} were the concentrations of NH₄⁺, K⁺, and Na⁺ in the recovered solutions, and Q_{RR} was the charge passing through the RR electrode in the recovery processes.

### Detection of Active Chlorine (AC).

The concentration of the produced AC at the anode was detected by iodometric titration. Specifically, the following steps were taken: 1) 1.000 g KI (>99%, Sigma-Aldrich) was first dissolved in 10 mL acetate buffer with a pH of ˜ 3.7. 10 mL sample solution containing CIO was added into the above solution, and the color of the solution changed to yellow. 2) The sample solution was then titrated using 1.00 mM standard Na₂S₂O₃ solution until the yellow solution became colorless. 3) Add 1.0 mL 0.5 wt % starch solution as the indicator (the color of the sample solution became brownish red), then continuously titrate with 5.00 mM standard Na₂S₂O₃ solution until the color disappeared. Finally, the concentration of the produced NaCIO was calculated with the volume of the 5.00 mM Na₂S₂O₃ solution consumed using the following equations:

ClO⁻+2I⁻+2H⁺→Cl⁻+I2+H₂O (4)

I₂+2S₂O₃²⁻→2I⁻+S₄O₆²⁻(5)

The FE of NaCIO production reaction was calculated using the following equation:

$$FE ( \% ) = \frac{Q for [ C {10}^{-} ] production}{{Q}_{input}} \times 100 = \frac{[ C {10}^{-} ] \times V \times 2 \times 96485}{{Q}_{input}} \times 100 \qquad ( 6 )$$

where V, [ClO⁻], and Qᵢₙₚᵤₜ are the volume of the solution, the concentration of produced NaClO, and the input charge during the electrolysis, respectively.
NH₄⁺ Recovery From Manure Wastewater Using RR Electrodes.

The NH₄⁺-uptake cell (Cell_{N-uptake}) containing 2 mL manure wastewater and the NH₄⁺-release cell (Cell_{N-release}) with 10 mL 0.1 M Li₂SO₄ solution (PH ˜2) were used to recover NH₄⁺ from manure wastewater. The KNiHCF RR electrodes with a size of 2×2 cm² and a total active material loading of ˜1200 mg were used in both cells. In Cell_{N-uptake}, a SCE electrode was used as the reference electrode to monitor the potential of the RR electrode. In Cell_{N-release}, a Pt wire electrode and a SCE were used as the counter electrode and reference electrode. The NH₄⁺-release process using KNiHCF RR electrodes was measured under a constant current of 10 mA. COD removal was calculated according to the following equation to describe the consumption of organic matter over the NH₄⁺ recovery process:

$$COD removal ( \% ) = \frac{{[ COD ]}_{initial} - {[ COD ]}_{final}}{{[ COD ]}_{initial}} \times 100 \% \qquad ( 7 )$$

where [COD]ᵢₙᵢₜᵢₐₗ and [COD]_{final} are the amounts of COD in manure wastewater before and after recovery.

Three parallel recovery experiments were conducted, denoted as Run 1, Run 2, and Run 3. Typically, one NH₄⁺ recovery run included the NH₄⁺ uptake from manure wastewater and NH₄⁺ release in Li₂SO₄ solution. Cations in 2 mL manure wastewater were recovered only once, and the recovered ions were collected in 0.1 M Li₂SO₄ solution for each run. The RR electrodes were oxidized to 0.9 V vs. SCE before use. For each run, in Cell_{N-uptake}, the reduction of RR and NH₄⁺ uptake occurred spontaneously. After a 24-h reduction process, the RR electrodes were washed with nanopure water and 0.1 M Li₂SO₄ solution to remove the residual electrolyte, then moved to Cell_{N-release}. In Cell_{N-release}, the oxidation of RR released intercalated cations until 0.9 V vs. SCE, which was paired with HER at the Pt cathode. During these recovery processes, the capacity of the RR electrode was controlled by the potential and capacity restrictions to ensure the RR electrode was operated within the desired potential windows. The concentrations of cations in manure wastewater and recovered solutions were measured by IC and the ion selectivity, nutrient selectivity, and FE were calculated based on the above equations. For the 50 recovery runs, each run included a 10-hour NH₄⁺ uptake in manure wastewater and nearly 2-hour electrochemical NH₄⁺ release. The COD removal and nutrient selectivity were analyzed every 5 runs.

NH₄⁺ Recovery From Manure Wastewater and H₂ Production.

NH₄⁺ recovery and H₂ production were demonstrated in two cells, the NH₄⁺-uptake cell (Cell_{N-uptake}) containing 10 mL manure wastewater and the H₂ cell (Cell_{H}_{₂}) with 25 mL 0.1 M (NH₄)₂SO₄ solution (pH ˜1.3). The KNiHCF RR electrodes with a size of 4 ×4 cm² and a total capacity of 892 C were used in both cells. The NH₄⁺-release process using KNiHCF RR electrodes was measured under a constant current of 45 mA. The electrochemical configurations and operations were the same as those in “NH₄⁺ recovery from manure wastewater”, except using (NH₄)₂SO₄ solution rather than Li₂SO₄ solution. The concentrations of cations in manure wastewater and recovered solutions were measured by IC and the ion selectivity, nutrient selectivity, and FE were also calculated based on the above equations. Finally, the recovered solution was dried to acquire solid product powder, and the PXRD pattern of the sample was collected.

Electrochemical Characterization of the Electrocatalytic H₂O₂ Production.

All electrocatalytic characterizations were performed using a Bio-Logic SP-200 potentiostat or a Bio-Logic VMP-3 multichannel potentiostat at room temperature.

### Preparation of Fe-CNT Electrodes.

10 mg of as-prepared Fe-CNT catalyst was typically mixed with 1 mL of ethanol and 100 μL of Nafion 117 solution (5%) and then sonicated for 2 h to get a well-dispersed catalyst ink. Next, a fixed volume of catalyst ink was drop-cast onto the Toray carbon paper (TGP-H-060, Fuel Cell Store) and then dried under ambient conditions. The mass loading of each electrode was around 1 mg with 100 μL catalyst ink.

H₂O₂ Production and Detection.

The H₂O₂ production reaction was performed in an H-cell separated with a glass frit (89057-758, ACE glass Incorporated, USA), using a Fe-CNT electrode as the working electrode, a Pt wire as the counter electrode, and a SCE reference electrode in 1 M NH₄Cl, 1 M NH₄Cl+1 M KCl, and 1 M KCl solutions. Prior to the measurements, the electrolyte solution was purged with O₂ gas for at least 15 min. Then, the electrocatalytic performance of the Fe-CNT electrode was investigated in the above solutions with continuous O₂ gas bubbling via CV and linear scan voltammetry (LSV) at 50 mV s⁻¹, and chronoamperometry (CA) at different potentials (−0.454, −0.554, −0.654 V vs. SCE). All potentials measured against SCE were converted to the reversible hydrogen electrode (RHE) scale using E_{RHE}=E_{SCE}+0.241 V+0.059×pH, where the pH values of solutions were determined to be 6.6˜6.8 using an Orion 810 BNUWP ROSS Ultra PH meter.

The concentration of the H₂O₂ generated from CA was quantified by the colorimetric titration with ceric sulfate. The sample solution containing H₂O₂ with a proper volume was added into 5.0 mL 0.4 mM Ce(SO₄)₂ solution and measured by UV-Vis spectroscopy at 319 nm. The concentration of H₂O₂ could be determined by the following equations:

$$2 {Ce}^{4 +} + {H}_{2} {O}_{2} \to 2 {Ce}^{3 +} + 2 {H}^{+} + {O}_{2} \qquad ( 8 )$$

$$[ {H}_{2} {O}_{2} ] ( mM ) = \frac{{V}_{1} \times [ {Ce}^{4 +} ] - ( {V}_{1} + Δ V ) \times [ {Ce}^{4 +} , detected ]}{Δ V \times 2} \qquad ( 9 )$$

where V₁, ΔV, [Ce^{4 +}] and [Ce^{4 +}, detected] are the original volume of 0.4 mM Ce^{4 +} standard solution, the volume of added H₂O₂ sample solution, the concentration of standard Ce^{4 +} solution, and the detected concentration of Ce^{4 +} solution after adding H₂O₂ sample, respectively. In this experiment, V₁ was 5.0 mL and [Ce^{4 +}] was 0.4 mM.

The FE of H₂O₂ production reaction was then calculated based on the concentration of detected H₂O₂ and input charge using the following equation:

$$FE ( \% ) = \frac{Q for {H}_{2} {O}_{2} production}{{Q}_{input}} \times 100 = \frac{[ {H}_{2} {O}_{2} ] \times V \times 2 \times 96485}{{Q}_{input}} \times 100 \qquad ( 10 )$$

where V, [H₂O₂], and Qᵢₙₚᵤₜ are the volume of the solution, the concentration of produced H₂O₂ and the input charge during the electrosynthesis, respectively.
NH₄⁺ Recovery From Manure Wastewater and H₂O₂ Production.

NH₄⁺ recovery and H₂O₂ production using the NH₄⁺ -selective RR electrodes were demonstrated in two cells, the NH₄⁺-uptake cell (Cell_{N-uptake}) containing 10 mL manure wastewater and the H-cell (Cell_{H}_{₂}_{O}_{₂}) with a glass frit (89057-758, ACE glass Incorporated, USA). In each chamber of the H-cell, 14 mL 0.5 M K₂SO₄ solution (pH ˜7) was used. The KNiHCF RR electrodes with a size of 4×4 cm² and a total capacity of 892 C were used in both cells. In Cell_{H}_{₂}_{O}_{₂}, two Fe-CNT electrodes (mass loading of each electrode around 1 mg) were used back-to-back as the working electrodes with a SCE reference electrode and the RR electrode as the counter electrode in the other chamber. The electrolyte solution was continuously bubbled with O₂ gas to ensure the O₂ saturation. The H₂O₂ production process using KNiHCF RR electrodes was measured under a constant current of 45 mA.

The operations were the same as those in “NH₄⁺ recovery from manure wastewater”, except the H₂O₂ production occurred on the Fe-CNT electrode in this configuration. For the 2-cycle recovery process with H₂O₂ production, cations in 10 mL manure wastewater were recovered twice, and the recovered ions were collected in a new 14 mL 0.5 M K₂SO₄ solution for each cycle. The same KNiHCF RR electrodes in these 1-cycle recovery processes were used. The concentrations of cations in manure wastewater and recovered solutions, ion selectivity, nutrient selectivity, and FE were analyzed and calculated based on the above procedure and equations. The recovered solution in the RR chamber was dried to get solid product powder, and the PXRD pattern of the sample was collected.

The concentration of the produced H₂O₂ was measured following the procedures described above. Based on the product concentrations, the Faradaic efficiencies were calculated according to the following equations:

$${FE ( \% )}_{{H}_{2} {O}_{2}} = \frac{Q for {H}_{2} {O}_{2} production}{{Q}_{passing , RR}} \times 100 = \frac{[ {H}_{2} {O}_{2} ] \times V \times 2 \times 96485}{{Q}_{passing , RR}} \times 100 \qquad ( 11 )$$

where V, [H₂O₂], and the Q_{passing,RR} are the volume of the solution, the concentration of produced H₂O₂, and the charge passing through the RR electrode, respectively.

### Example 2: Calculated Difference of Intercalation Potential Between NH₄⁺ and M⁺ (Cations With 1+ Charge) at Difference Molar Ratios of NH₄⁺ to M+

The intercalation potentials of different cations, E^{O}, were estimated based on E_{1/2} from cyclic voltammograms of the KNiHCF electrode in various solutions at 1 mV s⁻¹ (FIG. 8b and FIG. 10).

E^{O}_{NH}_{₄}_{⁺}=0.445 V vs. SCE, EE^{O}_{K}_{⁺}=0.437 V vs. SCE, E^{O}_{N}_{⁺}=0.325 V vs. SCE

E_{NH}_{₄}_{⁺}−E_{M}_{⁺} was calculated from the Nernst equation¹ shown below:

$${E}_{{NH}_{4}^{+}} = E {°}_{{NH}_{4}^{+}} - 0.059 \times log \frac{1}{[ {NH}_{4}^{+} ]} \qquad ( S1 )$$

$${E}_{{M}^{+}} = E {°}_{{NH}_{4}^{+}} - 0.059 \times log \frac{1}{[ {M}^{+} ]} \qquad ( S2 )$$

$${E}_{{NH}_{4}^{+}} - {E}_{{M}^{+}} = E {°}_{{NH}_{4}^{+}} - E {°}_{{M}^{+}} - 0.059 \times log \frac{[ {M}^{+} ]}{[ {NH}_{4}^{+} ]} \qquad ( S3 )$$

When E_{NH}_{₄}_{⁺}−E_{M}_{⁺}>0, the NH₄⁺ intercalation is thermodynamically favorable for the KNiHCF electrode. When E_{NH}_{₄}_{⁺}−E_{M}_{⁺}<0, the NH₄⁺ intercalation is thermodynamically unfavorable, and the KNiHCF electrode prefers M⁺ intercalation.

### Example 3: Coulombic Efficiency During the Ammonium Recovery Process in Manure Wastewater

The Coulombic efficiency, defined as the ratio of the charges passing through the RR (C_{RR}) to the charges needed for COD removal (C_{COD}),

$$CE related to COD removal = \frac{{C}_{RR}}{{C}_{COD}} \times 100 \% \qquad ( S4 )$$

is used to evaluate the efficiency of organic-to-electricity over the recovery processes. C_{COD} could be calculated based on the measured COD removal in manure wastewater and Faraday's constant. For example, the initial COD is 24.04 g L⁻¹, the COD removal is 30%, and the volume of manure wastewater is 2 mL. The COD removal is 0.0144 g O₂, equal to 4.51×104 mol O₂. Then the charge based on COD removal was n(O₂)×F×4=174 C. Here the C of RR is the charge passing through the RR electrode during the electrochemical NH₄⁺ release process, which is measured by the potentiostat. When C_{RR} is 60 C, the CE will be 34.5%.

We claim:

1. A method for recovering NH₄⁺ or K⁺ ions from manure wastewater, the method comprising:
contacting a manure wastewater comprising organic matter and salts with an ion-selective redox material comprising ionic channels, wherein contacting the manure wastewater with the ion-selective redox material reduces the ion-selective redox material to form a reduced material, and wherein the reduced material spontaneously takes up NH₄⁺ or K⁺ ions from the manure wastewater to form an ion-loaded material.

2. The method of claim 1, wherein the reduced material takes up NH₄⁺ and K⁺ preferentially over Na⁺.

3. The method of claim 1, wherein the ion-selective redox material is a Prussian Blue analog.

4. The method of claim 3, wherein the ion-selective redox material is one of potassium nickel hexacyanoferrate or copper hexacyanoferrate.

5. The method of claim 1, further comprising the steps of: applying a current to the ion-loaded material, wherein applying the current to the ion-loaded material oxidizes the ion-loaded material to release the NH₄⁺ or K⁺ ions from the ion-loaded material.

6. A method for utilizing NH₄⁺ or K⁺ ions, the method comprising: applying a current to an ion-loaded material, wherein applying the current to the ion-loaded material oxidizes the ion-loaded material to release NH₄⁺ or K⁺ ions from the ion-loaded material.

7. The method of claim 6, wherein the oxidation of the ion-loaded material is coupled to a cathodic reaction.

8. The method of claim 7, wherein the cathodic reaction is a hydrogen evolution reaction.

9. The method of claim 7, wherein the cathodic reaction is a two-electron oxygen reduction reaction producing H₂O₂ and optionally wherein the cathodic reaction is separated from the anodic reaction by a separator.

10. A system for treatment of manure wastewater, the system comprising:
a manure waste supply having manure wastewater therein,
a cell comprising at least one inlet and at least one outlet, and
a wastewater treatment chamber,
wherein the cell has an ion-selective redox material disposed therein,
wherein the inlet is fluidly coupled to the manure wastewater supply,
wherein the outlet is fluidly coupled to the wastewater treatment chamber,
wherein the manure wastewater flows from the manure waste supply into the cell through the inlet, contacts the ion-selective redox material, and exits the cell through the outlet to the wastewater treatment chamber, and
wherein the manure wastewater comprises organic material and salts.

11. The system of claim 10, wherein the organic material reduces the ion-selective redox material upon contact to form a reduced material, and wherein the reduced material spontaneously takes up NH₄⁺ ions or K⁺ from the manure wastewater to form an ion-loaded material.

12. The system of claim 10, wherein the ion-selective redox material is a Prussian Blue analogue.

13. The system of claim 12, where the ion-selective redox material is one of potassium nickel hexacyanoferrate or copper hexacyanoferrate.

14. The system of claim 10 wherein the ion-selective redox material is incorporated into an electrode having an electrical connection outside the cell.

15. The system of claim 14 wherein a current applied to the electrode through the electrical connection oxidizes the ion-loaded material and releases the NH₄⁺ or K⁺ ions.

16. The system of claim 15, wherein the oxidation of the ion-loaded material is coupled to a cathodic reaction.

17. The system of claim 16, wherein the cathodic reaction is a hydrogen evolution reaction.

18. The system of claim 16, wherein the cathodic reaction is a two-electron oxygen reduction reaction producing H₂O₂.

19. The system of claim 18, wherein the cathodic reaction is separated from the anodic reaction by a separator.

20. The system of claim 18, wherein the H₂O₂ is directed to the wastewater treatment chamber.
